(19) United States
(12) Patent Application Publication
(10) Pub. No.: US 2010/0211484 A1
(43) Pub. Date: Aug. 19, 2010

(54) ELECTRONIC BANKRUPTCY CLAIMS FILING SYSTEM

(75) Inventors: WILLIAM G. MALCOLM, SAN JUAN CAPISTRANO, CA (US); ARTURO M. CISNEROS, RIVERSIDE, CA (US); RAMA IYER, IRVINE, CA (US); RICARDO G. BRUTOCAO, LAGUNA HILLS, CA (US); HEIDI YUENLING MAK, IRVINE, CA (US); JOEL KARL LA FALL, STANTON, CA (US)

Correspondence Address: HOWISON & ARNOTT, L.L.P, P.O. BOX 741715, DALLAS, TX, 75374-1715, US

(73) Assignee: CENTERGISTIC SOLUTIONS, INC., ANAHEIM, CA (US)

(21) Appl. No.: 12/605,179

(22) Filed: Oct. 23, 2009

Related U.S. Application Data
(60) Provisional application No. 61/152,395, filed on Feb. 13, 2009.

(51) Int. Cl. G06Q 40/00; G06Q 10/00; G06Q 50/00; G06F 17/30; G06F 7/10

(52) U.S. Cl. 705/30; 705/7; 705/35; 707/E17.014; 707/E17.044; 715/760

(57) ABSTRACT

A system, method or apparatus that aids the management of electronic bankruptcy case related filings in a variety of court districts is provided. An exemplary system electronically receives bankruptcy case related proof of claim data or transfer of claim data from various loan or mortgage service providers. The received data may be reviewed, edited, standardized, audited and/or confirmed as being ready for transformation, according to predetermined court requirements, into proof of claim or transfer of claim electronic documents appropriate for filing with a selected court. An exemplary system may then electronically file, in a user originated or automated manner, such electronic documents via a selected court's electronic interface, receive an electronic filing receipt indicative of a successful filing therefore, and report such success electronic filing to the appropriate loan or mortgage service provider.

### CROSS-REFERENCE TO RELATED APPLICATIONS

This application claims the benefit of U.S. Provisional Application No. 61/152,395, filed on Feb. 13, 2009, and entitled ELECTRONIC BANKRUPTCY CLAIMS FILING SYSTEM, the specification of which is incorporated herein by reference.

### TECHNICAL FIELD

Embodiments of the invention relate to a system, method and software used for the automation of electronic bankruptcy case filings. More particularly, embodiments of the invention relate to a system, method, software and architecture that simplify and help to normalize a process of filing proof of claim filings and other bankruptcy related filings via an automated or semi-automated interface and system. Additionally, embodiments may provide a method, systems or software that performs aspects of a bankruptcy litigation audit.

### BACKGROUND

There are basically three main types of bankruptcy filings. The main bankruptcy filings include Chapter 11, 13, and 7 filings. Each of these types of bankruptcy filings allow the party filing for bankruptcy some time to sort out their financial circumstances. The most well used bankruptcy filings are Chapter 13 and 7 filings.

In general, chapter 7 and chapter 13 bankruptcy cases ensure that the party filing for bankruptcy is given temporary relief from payment obligations on existing debts. Payments for certain debts may resume upon confirmation of a chapter 13 plan of reorganization or upon the debtor's chapter 7 discharge.

For example, in a Chapter 7 filing, the bankruptcy filer is by definition agreeing to liquidate all of their disposable and non-exempt assets. These non-exempt assets, including both money and property, are pooled together into a collective bankruptcy estate and are turned over to a court appointed trustee. Upon examination of the estate, the trustee determines what assets may be liquidated and distributed to the benefit of the creditors. The payoff ratio of existing debts is dependent upon the size and value of the bankruptcy estate.

In a Chapter 13 bankruptcy filing, the debtor proposes a plan to pay back existing debts and restructure his estate for the future. The debtor's plan is subject to scrutiny and objection by the Chapter 13 trustee, the court and the debtor's creditors. Once the plan is confirmed by the trustee and the court, the bankruptcy filer has either 3 or 5 years to pay off his debts, depending on the length of plan.

If a party is a creditor of the bankruptcy filer, then the creditor must file a proof of claim with the appropriate court in order to have his debt repaid. How a creditor files a proof of claim can vary depending on the chapter under which the bankruptcy was filed. Only a creditor can file a proof of claim during bankruptcy. Failure to file a proof of claim may result in the creditor being paid only a percentage of his claim or nothing at all.

A claim is defined by the bankruptcy code in section 101(5) as a right to payment whether or not such right is reduced to judgment, liquidated, unliquidated, fixed, contingent, matured, unmatured, disputed, undisputed, legal, equitable, secured, or unsecured. 11 U.S.C. section 5(a). Section 101 also defines a claim as a right to an equitable remedy for breach of performance if such breach gives rise to a right of payment. 11 U.S.C. Section 101(5)(b). Only a creditor can have a claim to payment in a bankruptcy proceeding. Therefore, only a creditor can file a proof of claim.

How a proof of claim is filed depends upon the local jurisdictional requirements and the type of bankruptcy that has been filed. For example, there are different rules for proof of claims filed in a chapter 13 than those filed in a chapter 7 or 11. There are differences for proofs of claims filed in a chapter 9 and chapter 12 bankruptcy, but given they are infrequent such differences will not be specifically discussed herein. The bankruptcy petitioner, regardless of the chapter will list both secured and nonsecured claims in schedules as part of their initial petition with the court and trustee.

In Chapter 7 cases, an unsecured creditor must file a proof of claim in order to even be considered for repayment of that debt. FRBP 30000(a). The proof of claim must be filed no later than 90 days after the first date set for the meeting of creditors. In most districts, all known creditors must be provided notice of the location, time and date of the meeting of creditors. The Chapter 7 trustee sets the date appropriate for this meeting. Within that notice, the trustee may make a statement indicating there are no assets available in the particular case. Therefore, there are no assets that may be distributed to the benefit of any unsecured creditors. In that instance, unsecured creditors may not be required to file a proof of claim until the trustee gives notice to do so. In other words, a proof of claim will not need to be filed by an unsecured creditor until there is some realization of assets that may be liquidated to pay those unsecured debts. When the trustee is able to establish that there are assets in the estate, a notice and proof of claim form is sent to each creditor with a filing deadline. The specific procedure will vary depending upon the court district in which the bankruptcy is filed.

In Chapter 7 cases, creditors with secured claims are not required to file a proof of claim. 11 U.S.C. Section 506(d)(2). However, a secured creditor is ‘secured’ only to the extent of the value of the underlying collateral. 11 U.S.C. 506(a). Any debt that exceeds the value of the collateral, is not secured and is bifurcated from the secured claim. If a secured creditor is partially unsecured, then they must file a proof of claim under section 726 of the bankruptcy code in order to entitlement of any distribution of the estate's assets.

The procedure for a Chapter 11 case is different from a Chapter 7. The most significant difference is that a secured creditor is not required to file a proof of claim so long as they are listed in the debtor's schedules and their claim is not disputed by the debtor or any creditor, it is not unliquidated, and it is not contingent upon some further action by any party. If the claim is disputed, unliquidated, or contingent, then the creditor must file a proof of claim.

In Chapter 11 cases, there is not a set date in which a creditor must file a proof of claim. Any bar date to filing will be set by the court on a case per case basis. Once decided by the court, the debtor is required to give a 20 day notice to all creditors of the bar date for filing any proof of claim.

The debtor's schedules of claims in a chapter 11 are not mailed out to the creditors but rather filed with the court directly. These schedules indicate to the creditor the amount the debtor believes to be in debt and how much the debtor is anticipating repaying. These schedules may also act as a guideline to the court in setting potential proof of claim bar dates. The proof of claim form sent to the creditors, does not list the amount owed or the status owed to the creditor. Based on the claim form alone, it is often hard for a creditor in a chapter 11 to determine what they are owed. Quick and convenient access to the debtor's schedules would be advantageous to a creditor in this circumstance.

In a chapter 13 case, filing a proof of claim is crucial. An unsecured creditor must file a proof of claim in a Chapter 13 case if they wish to recover the debt. If a proof of claim is not filed, the unsecured creditor will be barred from any right to distribution. 11 U.S.C. 502(b)(9). Moreover, a Chapter 13 is dependent upon a feasible plan of reorganization. As such, if a proof of claim is not timely filed, then the unsecured creditor's claim is not only barred but it is also discharged. 11 U.S.C. Section 1328(a).

Secured creditors in a Chapter 13 case may not necessarily have to file a proof of claim. However, if the secured creditor does not file a proof of claim then the debtor may do so on the creditor's behalf in order to establish the amount of the claim to be repaid. 11 U.S.C. Section 501(c). If a debtor does file a claim, then a secured creditor should also file a proof of claim in order to establish the amount that they are owed according to their own calculations, rather than the debtor's calculations.

The basic procedure for filing a proof of claim is the same in a Chapter 7, 11, or 13 case. Firstly, the claim must be in writing. FRBP 3001. Furthermore, the proof of claim must conform to the Official Form 10 contained as an appendix to the Bankruptcy code. A proof of claim must be signed by either the creditor or the creditor's agent. FRBP 3001(B). If the proof of claim is based on a writing, such as a contract, the writing should accompany the proof of claim. FRBP 3001(c). If the proof of claim is a secured claim, proof of perfection of the security interest must also accompany the proof of claim, such as a deed of trust. FRBP 3001(d). Lastly, a proof of claim form must be filed in the district where the bankruptcy case is pending. FRBP 3002(b), FRBP 5005(a).

As indicated by the above and the indicated code sections, which are incorporated herein by reference, filing a proof of claim is not a straightforward task. Filing a proof of claim requires a significant amount of both legal and business knowledge so that it is performed correctly by a legal practitioner. The filing of a proof of claim involves several intertwining Bankruptcy Code sections as well as rules unique to the District Court in which the case was filed. Different practitioners may have differing techniques of wording proof of claim forms or may confuse or inadvertently overlook a specific Bankruptcy Code rule or District Court filing requirement for a variety of reasonable reasons.

Most, if not all, courts that handle bankruptcy cases now have a process of accepting an electronically filed of a proof of claim. Proof of claim filers can obtain a limited access login and password to a bankruptcy court's electronic proof of claim filing system. To date, different bankruptcy courts utilize differing software to receive proof of claim filings, which adds to the complexity and potential frustration of having multiple login/password combinations for multiple courts and having to navigate different graphical user interfaces on different bankruptcy court electronic filing systems and software.

As such, what is needed is a system and method for gathering proof of claim information, organizing such information and filing a proof of claim in a standardized and potentially automated fashion according to the rules of the District Court that the bankruptcy case is filed without having to be intimately knowledgeable of the varying navigation of the different electronic filing systems and individual specific formatting requirements and slight variances of the various bankruptcy courts.

### SUMMARY

The following are exemplary summaries of various embodiments of the invention:

A first aspect of an exemplary embodiment of the invention provides an electronic bankruptcy claims filing system, the filing system comprises a computer device, the computer device comprises a computer readable medium; at least one input/output port adapted for connection to a network; a processor electronically coupled to the computer readable medium and to the at least one input/output port; and a plurality of instructions wherein at least a portion of the plurality of instructions are storable in the computer readable medium, and further wherein the plurality of instructions are configured to cause the first processor to perform the steps of accepting a proof of claim data file from a servicer platform via the input/output port; verifying that predetermined data items are present in the proof of claim data file; creating a proof of claim database file in the computer readable medium for storing proof of claim data, the proof of claim data comprising at least the predetermined data items; storing the predetermined data items in the proof of claim database file; providing a pass code protected browser interface for a bankruptcy specialist to access, the pass code protected browser interface comprising a graphic user interface for the bankruptcy specialist to view, edit, add to or confirm the proof of claim data in the proof of claim database file; transforming the proof of claim data into at least one electronic document in accordance with requirements of a selected court district in which a proof of claim is to be filed, the at least one electronic document comprising at least one of a B-10 form, an Exhibit form, and a Proof of Service form; invoking a session with the selected court district's electronic filing system via the at least one input/output port; navigating, without human interaction, the selected court district's electronic filing system's graphic user interface and searching for a specific electronic bankruptcy case file; uploading the at least one electronic document, via the at least one input/output port, to the selected court district's electronic filing system in order to file the proof of claim with the specific electronic bankruptcy case file; receiving a proof of claim filing receipt from the selected court district's electronic filing system via the at least one input/output port; and updating a proof of claim database file to indicate that a proof of claim filing receipt was received; and storing the proof of claim filing receipt in the proof of claim database file.

The first aspect of the invention may further comprise a plurality of proof of claim database files stored on the computer readable medium, and also wherein the pass code protected browser interface further comprises a graphic user interface for the bankruptcy specialist to selectively view, edit, or confirm specific proof of claim data associated with a selected one of the plurality of proof of claim database files.

The first aspect of the invention wherein the proof of claim data comprises case number information, bankruptcy court information, creditor information, debtor information, claim amount information, attorney information, trustee information, late charges information, and fees information.

The first aspect of the invention further comprising performing a litigation audit on the predetermined data items if the bankruptcy specialist selects a litigation audit to be performed via the graphic user interface.

The first aspect of the invention further comprising a court login credential file stored in the computer readable medium, the court login credential file comprises court login credentials for a plurality of court district's electronic filing systems, and wherein the selected court district's electronic filing system is one of the plurality of court district's electronic filing systems.

The first aspect of the invention wherein the electronic documents further comprise loan documents.

The first aspect of the invention wherein accepting the proof of claim data file from the servicer platform via the input/output port further comprises checking a predetermined storage location for a new proof of claim data file.

The first aspect of the invention wherein accepting the proof of claim data file from the servicer platform via the input/output port further comprises validating a service provider's login credentials prior to accepting the proof of claim data file and sending an acknowledgement to the servicer platform indicative of a receipt of the proof of claim data file.

The first aspect of the invention further comprising providing status of a proof of claim to a service provider, wherein providing status comprises validating a service provider's login credentials prior to accepting a proof of claim status request from the service provider, the proof of claim status request comprises information that identifies a particular proof of claim data file; generating a proof of claim status report incorporating information from the particular proof of claim data file; and providing the proof of claim status report to the servicer platform electronically.

The first aspect of the invention wherein the computer device is a server device.

In a second aspect of an exemplary embodiment of the invention, an electronic bankruptcy claims system comprises a computer device comprising a computer readable medium; at least one input/output port adapted for connection to a network; a processor electronically coupled to the computer readable medium and to the at least one input/output port; and a plurality of instructions, wherein at least a portion of the plurality of instructions are storable in the computer readable medium. The plurality of instructions are configured to cause the first processor to perform the steps of accepting a claim data file from a servicer platform via the input/output port, the claim data file being one of a proof of claim data file and claim transfer file; creating a claim database file in the computer readable medium for storing claim data, the claim database file comprising a data type indicating whether the claim database file comprises proof of claim data or claim transfer data; storing the predetermined data items in the claim database file; providing a pass code protected browser interface for a bankruptcy specialist to access, the pass code protected browser interface comprising a graphic user interface for the bankruptcy specialist to view, edit, add to or confirm the claim data in a bankruptcy specialist selected claim database file; transforming the proof of claim data into at least one electronic document, each electronic document in accordance with specific requirements of a selected court district in which a proof of claim is to be filed if the data type indicates that the claim data in the bankruptcy specialist selected database file comprises proof of claim data and the bankruptcy specialist confirms the claim data, the at least one electronic document comprising at least one of a B-10 form, a 210 form, an Exhibit form, a Proof of Service form, a court mandated or designated form; transforming the claim transfer data into at least one electronic document in accordance with specific requirements of a selected court district in which a claim transfer filing is to be filed if the data type indicates that the claim data in the bankruptcy specialist selected database file comprises claim transfer data and the bankruptcy specialist confirms the claim data; invoking a session with the selected court district's electronic filing system via the at least one input/output port; navigating, without human interaction, the selected court district's electronic filing system's graphic user interface and searching for a specific electronic bankruptcy case file; uploading the at least one electronic document, via the at least one input/output port, to the selected court district's electronic filing system in order to file the at least one electronic document with the specific electronic bankruptcy case file; receiving a filing receipt from the selected court district's electronic filing system via the at least one input/output port; and updating a claim database file within a data store to indicate that the at least one electronic document was electronically filed and that the filing receipt was received; and storing the filing receipt in the proof of claim database file.

The second aspect of the invention, wherein the computer device is a server device.

The second aspect of the invention wherein if the data type indicates that the claim data in the database file comprises proof of claim data, then the claim data in the database file further comprises bankruptcy court data, case number data, debtor data, creditor data, attorney data, fee data and claim amount data.

The second aspect of the invention wherein if the data type indicates that the claim data in the database file comprises transfer of claim data, then the claim data in the database file further comprises bankruptcy court data, case number data, debtor data, transferee data and transferor data.

The second aspect of the invention further comprising performing a litigation audit on a bankruptcy specialist selected database file comprising proof of claim data if the bankruptcy specialist selects a litigation audit to be performed via the graphic user interface.

The second aspect of the invention wherein performing a litigation audit comprises applying predetermined rules associated with the selected court district to the proof of claim data, evaluating whether a proof of claim data conforms with the rule, and providing a result message to the bankruptcy specialist.

A third aspect of an exemplary electronic bankruptcy claims filing system comprising a computer device, wherein the computer device comprises a computer readable medium, and wherein the computer readable medium comprises a database, the database comprises a proof of claim database file and a claim transfer database file. The computer device further comprises at least one input/output port adapted for connection to a network; a processor electronically coupled to the computer readable medium and to the at least one input/output port; and a plurality of instructions wherein at least a portion of the plurality of instructions are storable in the computer readable medium, and further wherein the plurality of instructions are configured to cause the first processor to perform the steps of providing a browser interface for a bankruptcy specialist to access, the browser interface comprising a graphic user interface for the bankruptcy specialist to input, view, edit, add to or confirm data in a bankruptcy specialist created or selected proof of claim database file in the proof of claim database or a claim transfer database file in the claim transfer database; transforming the proof of claim database file into at least one electronic document if the bankruptcy specialist created or selected proof of claim database file is confirmed by the bankruptcy specialist, each electronic document being in accordance with specific requirements of a selected court district in which a proof of claim is to be filed, the at least one electronic document comprising at least one of a B-10 form, a 210 form, an Exhibit form, a Proof of Service form and a court mandated or designated form; transforming the claim transfer database file into at least one electronic document being in accordance with specific requirements of a selected court district in which a claim transfer filing is to be filed if the bankruptcy specialist created or selected claim transfer database file is confirmed by the bankruptcy specialist; invoking a session with the selected court district's electronic filing system via the at least one input/output port; navigating, without human interaction, the selected court district's electronic filing system's graphic user interface and searching for a specific electronic bankruptcy case file; uploading the at least one electronic document, via the at least one input/output port, to the selected court district's electronic filing system in order to file the at least one electronic document with the specific electronic bankruptcy case file; receiving a filing receipt from the selected court district's electronic filing system via the at least one input/output port; updating the database to indicate that the at least one electronic document was electronically filed and that the filing receipt was received; and storing the filing receipt in the database.

A fourth aspect of an exemplary article of manufacture for operating an electronic bankruptcy claims filing system, the article of manufacture comprises a computer readable medium; a plurality of instructions wherein at least a portion of the plurality of instructions are storable in the computer readable medium, and further wherein the plurality of instructions are configured to cause a processor in a computer to perform the steps of providing a browser interface for a bankruptcy specialist to access, the browser interface comprising a graphic user interface for the bankruptcy specialist to input, view, edit, add to or confirm data in a bankruptcy specialist created or selected proof of claim database file located in a proof of claim database or a claim transfer database file located in a claim transfer database; transforming the proof of claim database file into at least one electronic document if the bankruptcy specialist created or selected proof of claim database file is confirmed by the bankruptcy specialist, each electronic document being in accordance with requirements of a selected court district in which a proof of claim is to be filed, the at least one electronic document comprising at least one of a B-10 form, a 210 form, an Exhibit form, a Proof of Service form and a court mandated or designated form; transforming the claim transfer database file into at least one electronic document being in accordance with requirements of a selected court district in which a claim transfer filing is to be filed if the bankruptcy specialist created or selected claim transfer database file is confirmed by the bankruptcy specialist; invoking a session with the selected court district's electronic filing system via the at least one input/output port; navigating, without human interaction, the selected court district's electronic filing system's graphic user interface and searching for a specific electronic bankruptcy case file; uploading the at least one electronic document, via the an input/output port of the computer, to the selected court district's electronic filing system in order to file the at least one electronic document with the specific electronic bankruptcy case file; receiving an electronic filing receipt from the selected court district's electronic filing system via the one input/output port.

The fourth aspect of an exemplary embodiment wherein the plurality of instructions further comprises the steps of accepting a proof of claim data file from a servicer platform a second input/output device on the computer; verifying that predetermined data items are present in the proof of claim data file, the predetermined data items comprising case number data, debtor data, servicer data; and claim amount data; creating a proof of claim database file located in the proof of claim database, the predetermined data items comprising a subset of data items that can be stored in the proof of claim database file; and storing the predetermined data items in the proof of claim database file.

### BRIEF DESCRIPTION OF THE DRAWINGS

For a more complete understanding, reference is now made to the following description taken in conjunction with the accompanying Drawings in which:

FIG. 1 illustrates an exemplary system diagram of a bankruptcy claims filing system;

FIG. 2 illustrates a diagram of an exemplary bankruptcy claims filing system with respect to software modules therein;

FIG. 3 depicts an exemplary data import process flow of an exemplary bankruptcy claims filing system;

FIG. 4 depicts a data import process flow diagram of a web service based bankruptcy claims filing system;

FIG. 5 depicts a data feed process for an exemplary web services based bankruptcy claims filing system;

FIG. 6 depicts a status check process for checking proof of service status on an exemplary bankruptcy claims filing system;

FIG. 7 depicts a user interaction flow diagram for an exemplary bankruptcy claims filing system;

FIG. 8 depicts a court electronic bankruptcy filing system interaction flow diagram for an exemplary bankruptcy claims filing system;

FIG. 9 depicts a litigation audit flow diagram for an exemplary bankruptcy claims filing system;

FIG. 10 is an exemplary “graphic user interface” (GUI) bankruptcy proof of claim file status screen;

FIG. 11 is an exemplary GUI bankruptcy proof of claim confirm page screen;

FIG. 12 is an exemplary GUI bankruptcy proof of claim summary screen;

FIG. 13 is an exemplary GUI screen that provides general information about a proof of claim file;

FIG. 14 is an exemplary GUI screen for entering debtor information;

FIG. 15 is an exemplary GUI screen for entering attorney information;

FIG. 16 is an exemplary GUI screen for entering Trustee information;

FIG. 17 is an exemplary GUI screen for entering claim total information;

FIG. 18 is an exemplary GUI screen for entering claim related payment and late charges information;

FIG. 19 is an exemplary GUI screen for entering various proof of claim related fees and expenses;

FIGS. 20 and 21 are exemplary GUI screens for designating and uploading proof of claim related documents; and

FIG. 22 is an exemplary GUI screen for requesting a view of a filing receipt.

### DETAILED DESCRIPTION

Referring now to the drawings, wherein like reference numbers are used herein to designate like elements throughout, the various views and embodiments of the exemplary electronic bankruptcy claims filing systems are illustrated and described. In addition, other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Embodiments of the invention provide a single point or location for handling proof of claim management, proof of claim transfer management and proof of claim auditing, which allows vendors and servicers to effectively generate, file and manage proof of claim, transfer of claims from one servicer to another servicer and to run a litigation audit against one or more proof of claims to determine whether there are any potential litigation issues based on Trustee requirements or on any local, state or federal laws or requirements. The embodiments automate one or more of these processes and provide a single point user and/or service provider interface rather than requiring a multiple point interface multiple interfaces for the user to organize and perform the same tasks separately on differing systems. Embodiments further provide a system and software that allow a vendor or servicer to utilize a single system to manage all the proof of claims needs and requirements in multiple bankruptcy cases. Presently, each bankruptcy court has a different electronic interface program operating that allows a bankruptcy specialist, vendor or servicer to check the status or filing of their proof of claims. As such, in order to file or check the case status or filing of proof of claims, a vendor or servicer must check each court system's computer system separately. Furthermore, each court system interface has or provides a different user name/login, thus a user must keep track of multiple logins in order to log into each separate individual court system to check proof of claim or status information for any one or more bankruptcy cases.

In addition, various embodiments help standardize and normalize the proof of claim filing process for a service provider. An embodiment of the exemplary bankruptcy claims filing system effectively consolidates the plurality of bankruptcy court electronic filing systems into a single point of reference and interface. Embodiments allow a servicer to interact with the numerous different district courts' electronic filing systems without having to individually and manually log into each one of those court's electronic systems. Embodiment systems further normalize the filing processes such that proof of claims are filed in a standardized manner and in accordance with the requirements of each one of the plurality of bankruptcy court systems. Embodiments collect data and bankruptcy proof of claim related information, generate the electronic forms for filing proof of claims and automate the process of electronically filing each proof of claim in the necessary bankruptcy court's electronic filing system. The special filing requirements and formats for each court district or court filing system are programmed in or stored in databases within an exemplary embodiment such that the user is not required to have intimate knowledge of the proper forms or filing formats in each of the different bankruptcy court filing systems.

Embodiments may have a variety of different databases having various database file configurations and data file formats. Embodiments may also include software programs, programming code and program modules. For example, one database file configuration may be in a MS Excel format while another is in a SQL format. The MS Excel formatted database file may, for example, contain data provided from a service provider, while a SQL database file may contain data retrieved or read from a MS Excel database file after the data has been audited or reviewed by a bankruptcy specialist. Data files may contain text, graphic, media or other data formats pertinent to storing or filing information or documents electronically. The software programs, code or modules may be in a programming language, machine code or other format usable by a microprocessor, computer or computing system. Some of the database files, data files or programs may be stored on non-volatile hard drives while others are stored within solid-state memory devices or in other types of technologies. Whether discussing a database, a database file, a data file, a program, code or a program module herein, all such items shall be understood to be potentially stored in a data store. A data store is herein understood to comprise a single or multiple non-volatile memory device(s) or other types of non-volatile computer readable mediums that adapted to store databases, database files, data files, as well as programs, code or program modules. Such non-volatile memory device(s) may include one or more types of non-volatile memory including electro-mechanical, magnetic, optical, flash or other solid state or non-solid state types of non-volatile memory. It is further understood that one of ordinary skill in the art of designing computer systems understands that not all database file information, data file information and software always reside in non-volatile memory, but instead may be stored temporarily during operation of an embodiment in various types of volatile memory. Furthermore, other types of computer readable mediums include, without limitation, magnetic and optical computer readable mediums, flash memory, battery backed volatile memory as well as reasonable facsimiles or derivations thereof.

Additionally, embodiments of the present invention may perform a proof of claim audit by reviewing data associated with a proof of claim file or filing and identify potential discrepancies or issues that could become ripe for litigation. Such an exemplary proof of claim audit module will alert the user to re-review, double-check or amend aspects of a proof of claim filing to help eliminate a risk of possible litigation.

Furthermore, embodiments of the invention provide an ability for preparing and filing documentation requesting the transfer of responsibility for one or more proof of claims filings from one service provider to another service provider. Such a transfer of such proof of claim filings is automated within exemplary embodiments of the present bankruptcy claims filing system. As part of preparing and filing of a claim transfer request, a claim transfer audit module may be used to alert the user to re-review, double-check or amend aspects of the claim transfer request data or documentation in order to help eliminate or minimize potential litigation risks. The litigation audit module(s) may be programmed to audit the data or information contained in proof of claim filings and claim transfer filings as well as other bankruptcy related court filings such as the information or data to be provided in a bankruptcy related court mandated or designated document.

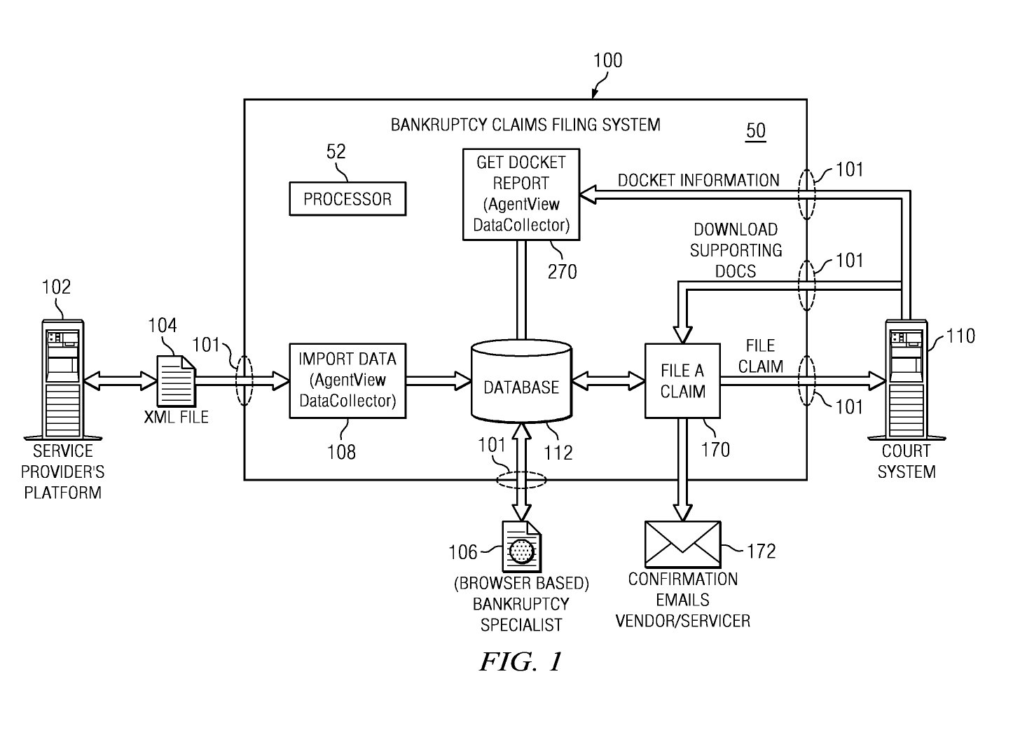

Referring now to FIG. 1, an exemplary block and system diagram of a bankruptcy claims filing system 100 is provided. An exemplary bankruptcy claims filing system 100 may be comprised within one or more multipurpose computers or server devices 50 having one or more programs or program modules stored in a memory media or computer readable medium. The instruction of the one or more programs or program modules may be read or interpreted by a processor 52 present in the multipurpose computer or server device 50 in order to perform the method(s) or functions of an exemplary electronic bankruptcy claims filing system 100. An exemplary bankruptcy filing system 100 generally receives data in the form of an XML file 104, via an input/output port 101, from either a loan or a mortgage service provider 102 or from a bankruptcy specialist via browser software and/or a graphic user interface (GUI) 106. The bankruptcy claims filing system 100 reconfigures and reformats the received data such that the data can be provided in an automated fashion to a selected bankruptcy court's electronic filing system 110. The data 104 from the service provider's platform 102 and/or the bankruptcy specialist 106 is transformed into a differing format or data structure in accordance with the varying requirements of different bankruptcy court electronic filing systems 110. Such transformation of the data may be done without a user's specific knowledge of each individual court system's electronic filing system 110 set requirements for proper data input and information in a proof of claim filing.

The servicer platform 102 or mortgage server system may be a servicer platform that is owned by or licensed from a third party and/or a system that operates on third party, proprietary or custom software. Such third party software may comprise established service provider software such as Mortgage Serve, DRI, Lenstar, Fidelity based software or other software used for managing mortgages or loans by a service provider such as a lender, bank or other financial institution. The software on service provider systems may contain and organize market and loan information for the service provider. These third party systems organize and manage many of the service provider's mortgages. Service providers receive information (not specifically shown) and update their own systems 102 such that they have the knowledge of whether mortgages and/or loans are or are not being paid. Furthermore, these third party systems tend to procure or analyze information related to when a debtor goes into a bankruptcy or is headed toward a bankruptcy proceeding based on non-payment or back payment of loans and mortgages, defaults, late fees and other charges associated with non-payment of a mortgage or other type of loan. Under certain circumstances, a servicer platform 102 will create an XML data file 104 or other data file and incorporate various information into the XML file 104 pertinent to obtaining information with respect to a potential or actual filing of a bankruptcy by a mortgage or loan holder. The XML file 104 is provided by the servicer platform 102 to an exemplary bankruptcy claims filing system 100 via an input/output port 101.

An exemplary bankruptcy claims filing system 100 may require that certain information be provided in an XML file 104. Such information may include, but is not limited to, one or more of the bankruptcy case number, the Chapter of the bankruptcy filing (7, 11, 13), the debtor's name, the debtor's attorney, the Trustee assigned to the bankruptcy, the amount of the loan that was lent, the amount of money that is secured, the amount of the loan that is unsecured, the delayed payments, the late charges, any other charges that may be applied such as attorney fees, foreclosure fees, inspection fees, the court district where the bankruptcy case is filed and the jurisdiction where the property or other collateral is located. In some embodiments, the creditor or service provider's information (i.e., name, address, ID number) is not necessarily required to be within the XML file 104 because the service provider is the party that logged onto an exemplary bankruptcy claims filing system 100 via the service provider's servicer platform 102 using an assigned user name/password login credentials. (Note: The service provider and the creditor are generally the same party.)

In some embodiments of the invention, a bankruptcy specialist using a browser and/or GUI 106, via the bankruptcy claims filing system 100 prompts the servicer platform 102 to send any or all pending XML files to the bankruptcy claims filing system 100. In other embodiments, the bankruptcy specialist, using the browser-based interface 106, may request specific XML files 104 for specific debtors or borrowers to be sent to the bankruptcy claims filing system 100. In yet other embodiments, the servicer platform 102 may have been programmed or set up to provide the XML files 104 as they become available or via a predetermined schedule. Thus, in different embodiments of the invention, XML file data 104 may be pushed by the servicer platform 102 to the exemplary bankruptcy claims filing system, pulled in an automated fashion from a service provider platform 102 or manually requested via a bankruptcy specialist, using a user interface 106, from the servicer platform 102 into an exemplary bankruptcy claims filing system 100. As such, XML file data 104 may be provided daily, weekly, periodically, at random intervals or as determined by either the bankruptcy specialist 106 or the servicer operating the servicer platform 102. In other words, an exemplary bankruptcy claims filing system may actively request or passively receive XML files 104 from one or more servicer platforms 102. Example 1, below, depicts an exemplary XML data file 104 formatted in an exemplary format with exemplary data that may be provided by a servicer platform 102 and received by an exemplary bankruptcy claims filing system 100.

```
TABLE 1
<?XML VERSION=“1.0” ENCODING=“UTF-8” ?>
- <BkrCases>
- <Case Number=“08-122208CF” VendorFileNo=“14400.92” InvestorNo=“901926”>
  <BkrFilingInfo District=“Eastern” Division=“Helena” County=“” State=“AR” DateFiled=“11/21/2007”
Code=“13” />
  <Debtor FirstName=“Melvin” MiddleName=“” LastName=“Gamble” Address=“168 Helendale” City=“Helena”
State=“AR” Zip=“72342” Phone=“” Fax=“” email=“” />
  <Debtor FirstName=“Sherrye” MiddleName=“” LastName=“Gamble” Address=“168 Helendale” City=“Helena”
State=“AR” Zip=“72342” Phone=“” Fax=“” email=“” />
  <DebtorAttorney FirstName=“Kent” MiddleName=“” LastName=“Pray” Address=“P.O. Box 94224” City=“N.
Little Rock” State=“AR” Zip=“72190” Phone=“” Fax=“” email=“” />
  <Trustee FirstName=“David” MiddleName=“D” LastName=“Coop” Address=“P.O. Box 5006” City=“N. Little
Rock” State=“AR” Zip=“72201” Phone=“” Fax=“” email=“” />
  <Vendor CompanyName=“MALCOLM & CISNEROS” ContactName=“William Malcolm” ContactTitle=“CEO”
Address=“2112 Business Center Drive, Second Floor” City=“Irvine” State=“CA” County=“Orange”
Zip=“92612” Phone=“(949)252-9400” Fax=“(949)252-1032” email=“bill@mclaw.org” />
  <Servicer CompanyName=“Carrington Mortgage Services, LLC” ContactName=“Ben Valarie”
ContactTitle=“Director of IT” Address=“1610 East Saint Andrews Place, Suite B150” City=“Santa Ana”
State=“CA” County=“Orange” Zip=“92705-1234” Phone=“800.561.4567” Fax=“800.561.4566”
email=“benat@nc.net” />
  <ClaimTotal LoanDocDate=“5/30/2003” Secured=“52037” Unsecured=“0.00” Priority=“0.00” Desc=“”
Remark=“” />
- <ArrearageTotal>
  <Payment Amount=“394.46” LateCharge=“19.72” Month=“06” Year=“07” />
  <Payment Amount=“394.46” LateCharge=“19.72” Month=“07” Year=“07” />
  <Payment Amount=“394.46” LateCharge=“19.72” Month=“08” Year=“07” />
  <Payment Amount=“394.46” LateCharge=“19.72” Month=“09” Year=“07” />
  <Payment Amount=“394.46” LateCharge=“19.72” Month=“10” Year=“07” />
  <Payment Amount=“394.46” LateCharge=“” Month=“11” Year=“07” />
  <OtherCharge Text=“Prior BK Fees” Amount=“468.55” />
  <OtherCharge Text=“NSF Fee” Amount=“25.00” />
  <OtherCharge Text=“Property Inspection” Amount=“277.70” />
  <OtherCharge Text=“Escrow Shortage” Amount=“1137.49” />
  </ArrearageTotal>
- <UploadFiles>
  <File Name=“14400.92.pdf” Path=“C:\demo loan docs\” Desc=“Loan Doc” Process=“POC” />
  </UploadFiles>
  </Case>
  </BkrCases>
```

As one can see in Table 1, XML format is being used to provide a variety of types of data in the XML file. For example, the case number, vendor, file number, investor number, the court, district, county and state of the bankruptcy court, one or more of the debtor's names and addresses, the Trustee's name and address, a vendor or bankruptcy attorney name and address, the servicer's name and address along with contact information as well as missed payments, late charges, back fees and other fees such as property inspection and escrow shortage costs may all be included an exemplary XML file. Furthermore, one or more PDF files or electronic copies of particular documents necessary for filling a proof of claim or paths (or links) for finding, retrieving and uploading those particular documents may be attached or included along with the XML file to an exemplary bankruptcy claims filing system 100.

In another embodiment of the bankruptcy claims filing system 100, transfer of claims filing data may be provided from a service provider's platform 102 via an XML file 104 to an input/output port 101 of the bankruptcy claims filing system 100. Such a transfer of claims XML data file would be somewhat similar to a bankruptcy case XML file, as shown above in Table 1, but a transfer of claims XML file will contain at least the case number, the debtor's name, the claim amount, the transferor information and the transferee information. Generally, the transferee is already known by the bankruptcy claims filing system 100 because it is the transferee who logged into an exemplary bankruptcy claims filing system 100 using a predetermined logon/password. The transferee logged on because of a communication outside of an exemplary system 100 to have the proof of claim(s) associated with a bankruptcy case or cases transferred to them. The transferee may have purchased the loans or mortgages that are the subject of the bankruptcy case from the transferor and thus now requires such cases to be transferred. In other words, the transferee is generally a mortgage or loan servicer who is sending the XML data 104 and who has purchased or acquired a plurality of loans from another mortgage servicer(s).

An import bankruptcy data module 108, which is resident software having executable instructions and is part of the bankruptcy claims filing system, receives the proof of claims XML data files or transfer of claims XML data files from an input/output port 101. The import bankruptcy data module 108 may actively watch for the receipt of XML files 104 from service provider platforms. If an XML file is being pushed to the bankruptcy claims filing system 100, the import bankruptcy data module 108 receives the XML file 104 and inspects the data in the XML file to determine whether a predetermined minimum amount of data or pertinent has been provided therein. The import bankruptcy data module 108 may also make determinations as to whether aspects of the data in a received XML data file 104 are correct. For example, referring to the first couple lines of the XML file as shown in Table 1, the import bankruptcy data module may determine whether or not there is actually a bankruptcy court found in the Eastern Division, Helena County Arkansas or whether the case number “08-122208CF” is a valid pending case number. If an error is found, or if not enough data is provided within the received XML data file 104, the import bankruptcy data module 108 may reject the XML file and initiate a sending an error message to the service provider's platform 102 via the internet, a network or an email functionality.

When the import bankruptcy data module 108 receives an XML file 104 that provides at least a predetermined minimal amount of information for commencing a proof of claim filing or a transfer of claim filing then the import bankruptcy data module 108 passes the received data to a database (or data store) 112. The database 112, upon receiving new proof of claim filing data opens a new proof of claim file within the database 112 and organizes the data received from the XML file 104 in a predetermined format. If, alternatively, the database 112 receives new data relative to a transfer of claim filing, then the database 112 opens a transfer of claim file for the new information in a predetermined organized fashion. The database data is stored on a computer readable medium associated with or within the bankruptcy claims filing system computer or server device 50.

In additional embodiments of the invention, update XML files 104 may be received from a service provider's platform 102 by the import data module 108 and the import data module may determine from communicating with the database 112 that such a proof of claim or transfer of claims file already exists in the database 112. As such, any new or revised data that has not previously been received via a previous XML file 104 may be provided to the database 112 in the appropriate proof of claim file or transfer of claim file to further complete or update the contents of the appropriate database file within the database 112.

In various embodiments, the bankruptcy claims filing system 100 also receives PDF or other electronically imaged documents from the service provider's platform 102 via I/O port 101. Such imaged documents may be copies of loan or mortgage related documents, including title to the loan, title to property, other documents used to secure the loan or required in a proof of claim filing. These PDF or other electronically imaged documents are then stored in the database 112 along with or with reference to their associated proof of claim case file. These documents, like an XML file, may be pushed from the service provider's platform 102 or pulled by the bankruptcy claim filing system 100 from the service provider's platform 102.

As discussed above, the import bankruptcy data module 108 may check the data received in an XML file for a variety of minimum requirements. For example, in some embodiments of the invention, the import bankruptcy data module 108 checks to make sure that there is contained in the XML file data 104 a valid case number, a valid attorney's name, a valid debtor's attorney, and Trustee. In the absence of certain critical pieces of information, a proof of claim case filing entry cannot be created reasonably by exemplary embodiments of the bankruptcy claims filing system 100. Furthermore, in some embodiments, an exemplary import bankruptcy data module 108 may not perform a detailed check on all the received data. For example, the import bankruptcy data module 108 may not check for accurate addresses or fee amounts within the received XML file.

In some embodiments, the import bankruptcy data module 108 is the module that creates new case files within the database 112 after minimal verification of the received data has been performed as discussed above. In other embodiments, another module that is more closely related to the database software creates and handles data files in database 112. Furthermore, other types of known or custom data files or derivations thereof may be used instead of XML data files 104 in various embodiments of the invention.

From time to time, a bankruptcy specialist or user may log on to an embodiment via a browser based graphic user interface 106. Once logged on, the bankruptcy specialist, via the browser or other graphic user interface 106 is presented a screen providing a listing of the new proof of claim file/cases that have been received from one or more service provider platforms 102 for which the bankruptcy specialist is responsible for reviewing. The graphic user interface/the browser 106 may indicate to the bankruptcy specialist that there are certain ones of the proof of claim files, which need to be reviewed by the bankruptcy specialist. Furthermore, other ones of the proof of claim files may need to be verified or acted upon by the bankruptcy specialist prior to those claims being made ready for filing in a specified bankruptcy court.

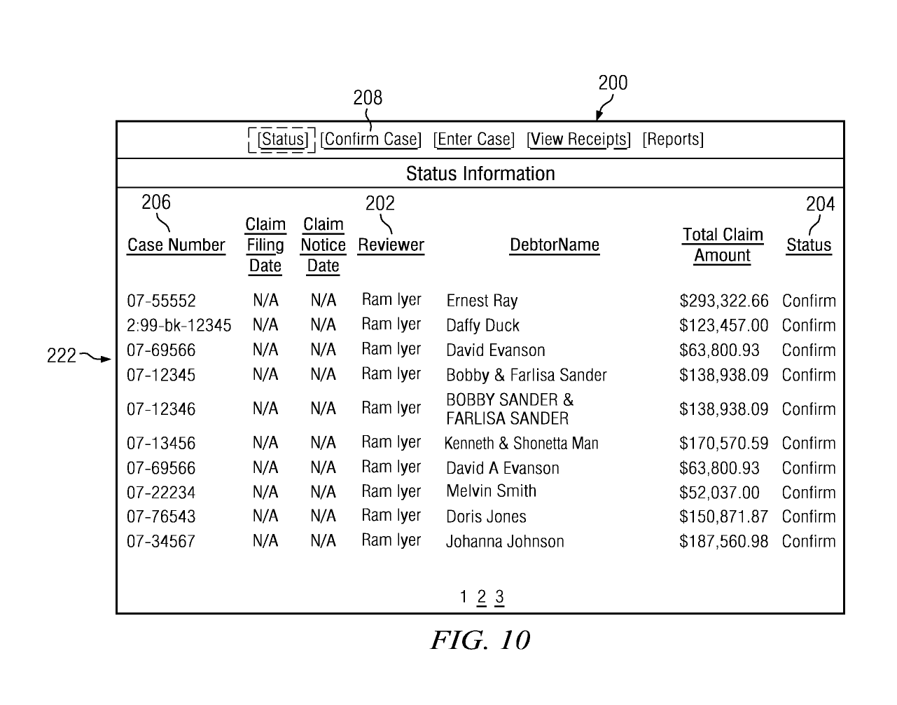

The bankruptcy specialist may log in via the browser/graphic user interface (GUI) 106 and navigate through various GUI screens. A first exemplary GUI screen that a bankruptcy specialist may use is a status screen, which is shown in FIG. 10. The status information screen 200 of FIG. 10 provides the general status of the various proof of claim cases for which a particular user/bankruptcy specialist 202 is responsible. The general status of each proof of claim case file is shown in the status column 204. The case number is shown in the case number column 206. By clicking on the confirm case link 208 the user 202 is taken to an exemplary confirm page screen 220 shown in FIG. 11. The confirm page screen 220 provides a listing of the proof of claim cases that the bankruptcy specialist 202 is to review and approve prior to the proof of claim being ready for filing. Referring to both FIGS. 10 and 11, for example, if the bankruptcy specialist wanted to look at a specific proof of claim case 222, he may follow that case to the confirmation page in FIG. 11 and click on the link to take him to review the summary 224.

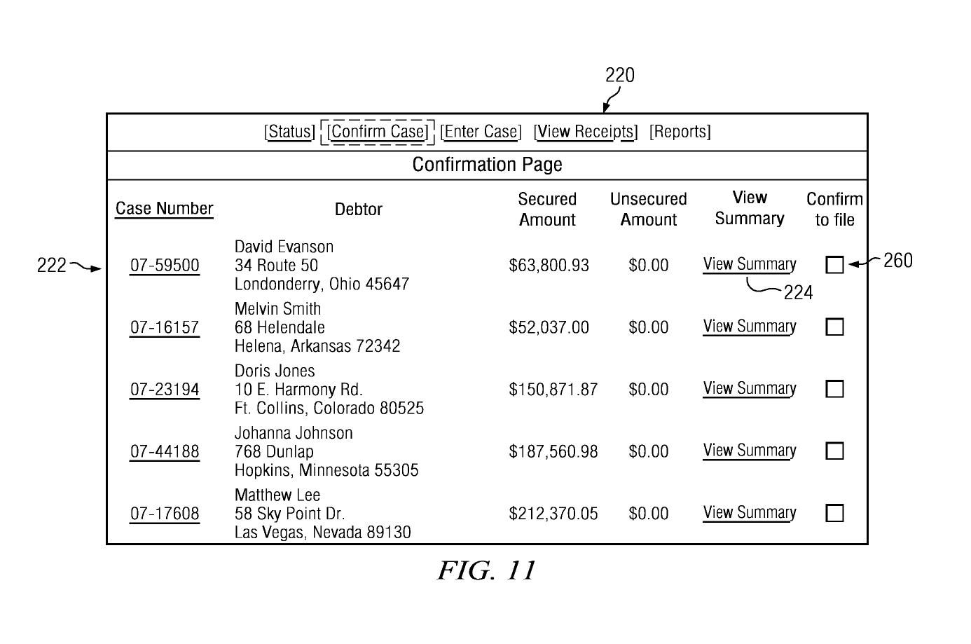

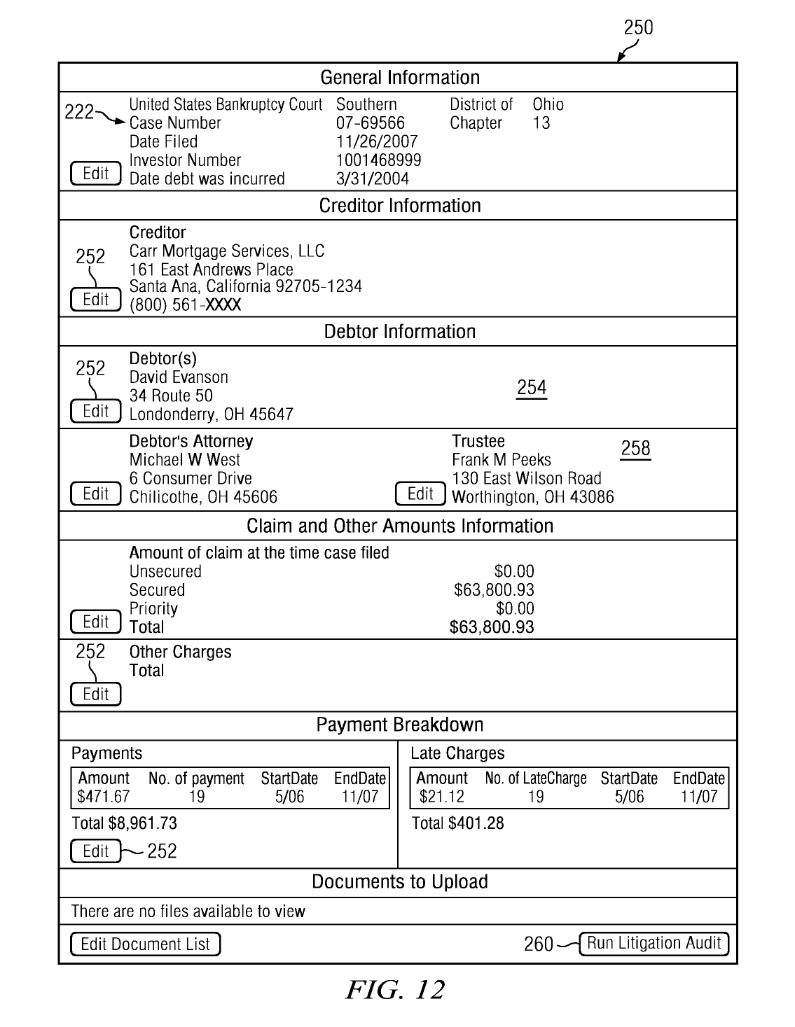

The exemplary summary or general information screen 250 is shown in FIG. 12 for the selected proof of claim case number 222. In the general information screen 250, the bankruptcy specialist can verify all the different information originally provided from a service provider's XML file 104 in a single view. The bankruptcy specialist may edit any of the various fields by clicking on a desired one of the various edit buttons 252. The bankruptcy specialist may add, change or delete information in the general information screen 250 for the particular proof of claim case 222 that is being viewed. The bankruptcy specialist may check to make sure that all the names and numbers appear to be correct or may verify such names and numbers using additional documentation (not specifically shown) provided from another source. Some of the common edits or changes made by a bankruptcy specialist in the general information screen page 250 may be the addition or deletion of additional charges or payments in Chapter 13 filings. The charges may need to be verified or supported using additional external documentation or data not acquired via the bankruptcy claims filing system 100. Sometimes the mortgage or service provider's systems 102 are behind with respect to being updated with real time data and the bankruptcy specialist will insert additional information related to unpaid payments or other charges that should be included in the proof of claim documentation. In yet other situations, various loan documents that could not have been provided or were not provided along with the electronically provided XML file 104 may have been provided to the bankruptcy specialist through other means such as fax, email, mail or other means. In these circumstances, the bankruptcy specialist may scan and/or upload the necessary or recently procured documents to be stored in the data store 112 in conjunction with the case number being reviewed 222. The general information screen and other aspects of the invention described herein are not limited for use only in Chapter 13 bankruptcy filings. On the contrary, the system, software and methods described herein may be generally or specifically designed for multiple types or chapters of bankruptcy filings via user selection or for a single specific type or chapter of bankruptcy filing.

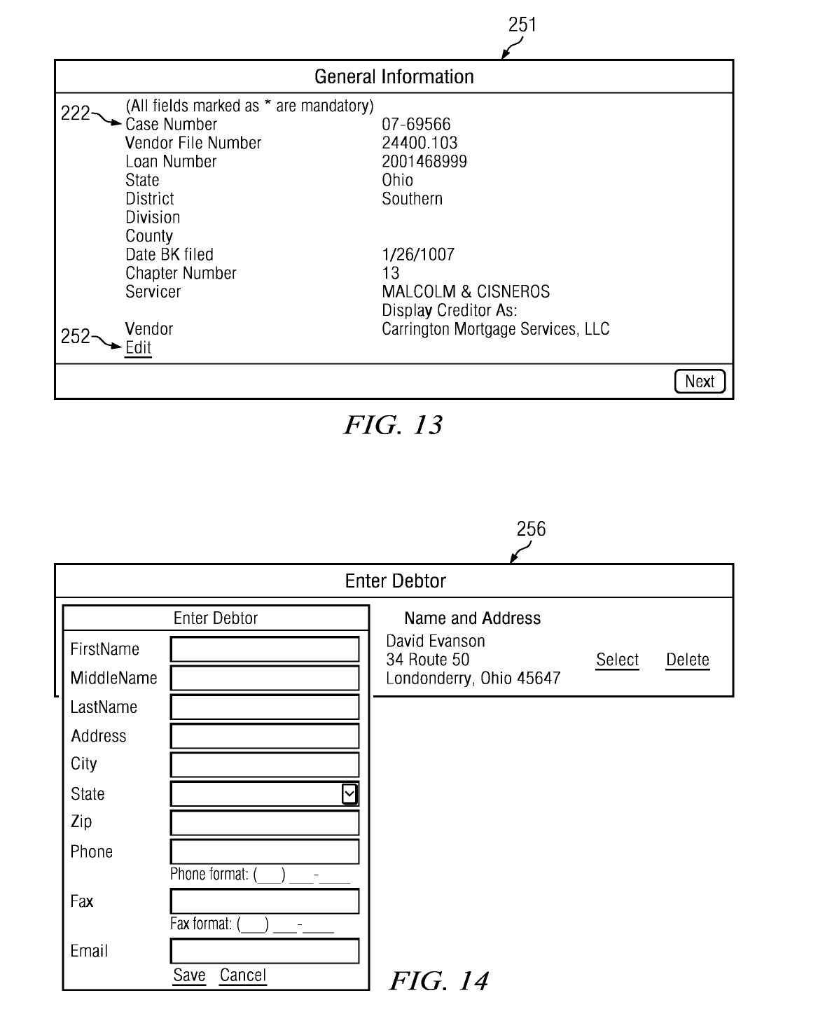

Additional exemplary general information screens 251 are shown in FIG. 13 for the selected case number 222. FIG. 13 shows the state, district and the bankruptcy chapter as well as the servicer and other information that may require review and verification by the bankruptcy specialist via the browser based graphic user interface 106.

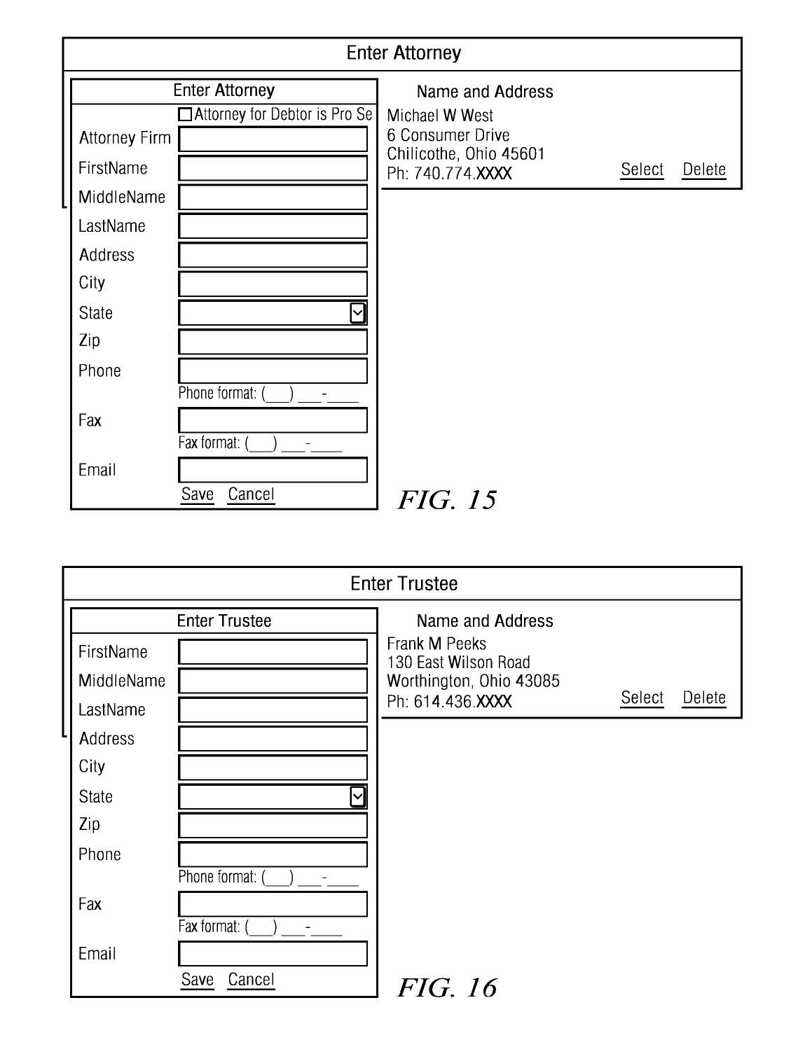

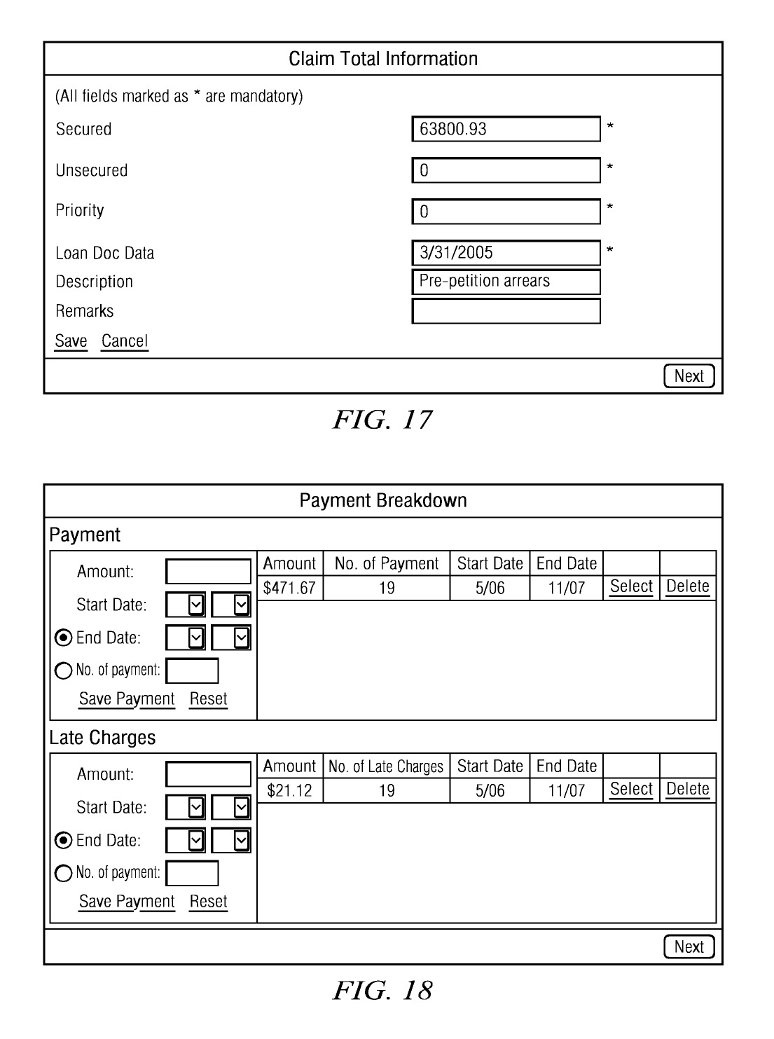

If the debtor information requires revision by the bankruptcy specialist, the bankruptcy specialist may select the edit button 252 in the debtor information area 254 of FIG. 12. This will take the bankruptcy specialist, or example, to an enter debtor information screen 256 shown in FIG. 14 wherein debtor information can be entered or revised by the bankruptcy specialist. If in FIG. 12 the debtor attorney information or the trustee information needs to be revised or edited by the bankruptcy specialist, the edit buttons in the debtor attorney or trustee area 258 can be pressed and the bankruptcy specialist will be taken to a screen shot similar to FIG. 15 to edit or update the attorney information or a display similar to that shown in FIG. 16 to enter, update or edit the trustee information. Similarly, FIGS. 17, 18 and 19 provide screen shots for editing the claim total information, claim payment breakdown information, and other information or amounts respectively.

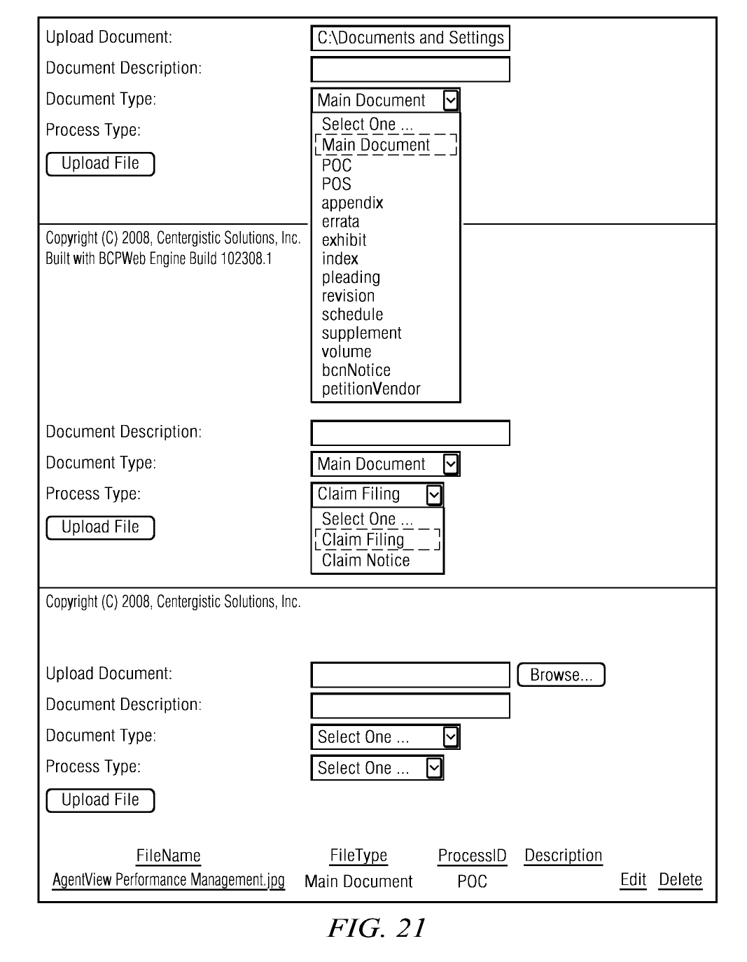

If additional documentation that was not provided along with the original XML file is provided to the bankruptcy specialist via another communication route (e.g., fax, email, mail) then such loan documentation may be uploaded along with the XML file using one or more of the upload additional document screens shown in FIGS. 20 and 21. For example, in FIG. 21, the bankruptcy specialist selects the type of document and location of the document in the filing system for upload and storage into the data store 112.

Referring back to FIG. 11, after the bankruptcy specialist is satisfied with his or her review, data entry and/or verification of all the data in the selected proof of claim case 222 via viewing and utilizing the various necessary screens such as the general information screen 250 and 251, the confirm file box 260 can be checked indicating to an exemplary bankruptcy claims filing system 100 that all the information for the selected case number 222 is ready for electronic filing in the indicated bankruptcy court using that bankruptcy court's required format. When the confirm to file button is selected, the reviewed and confirmed data is provided over to the file a claim module 170, which now has all of the necessary data that it needs to prepare and produce a properly formatted B-10 form, along with needed exhibit forms, petition documents and any other necessary documents that are to be included with the B-10 form when electronically filing the proof of claim. The exemplary system may also produce a proof of service document to indicate that an attorney or other entity is filing the proof of claim for the mortgage or service provider. Generally speaking, three electronic documents are prepared for a proof of claim filing, being a B-10 form, the exhibits, and a proof of service document. A pre-petition form may be included with the exhibit form, which basically includes all the charges associated with the proof of claim, including the amount of money that is being charged to the party that declared bankruptcy. After being electronically produced, the documents are ready for filing in the proper court handling the bankruptcy case proceedings.

Embodiments of exemplary bankruptcy claims filing systems, which use the data contents of received XML files 104 and associated electronic documents inclusive of edits or additional information provided by a bankruptcy specialist via the browser based GUI interface 106, can transform this data into a plurality of specific electronic documents that are used when electronically filing proof of claim filings in a bankruptcy court. In particular, embodiments of the invention may file such proof of claim documents in accordance with the appropriate and perhaps unique rules and requirements specified by the specific bankruptcy court and its associated electronic filing system.

Referring back to FIG. 1 and the designated bankruptcy case 222 of FIG. 11, when the bankruptcy specialist clicks on confirm to file 260, three documents (e.g., B-10 form, exhibit form, and proof of service form) may be prepared using the verified data in the data store 112. The data for the three documents is provided to the file a claim module 170 so that the electronic documents can be created in accordance with appropriate court's rules and requirements. In other embodiments, the electronic documents are created by a document creation software module (not specifically shown) that may be part of the database software module, the browser module or the file a claim module. Similarly, if claim transfer documents, for example a 210 bankruptcy claim transfer form, or other court designated or mandated documents require creation, these documents may be similarly created, reviewed and confirmed for filing by embodiments of the invention. In some embodiments wherein data is verified at and/or provided from a service provider's platform 102, a bankruptcy specialist may not be required to review and confirm the data prior to preparing and filing electronic documents with a court.

The file a claim module 170 uses data (electronic files or documents) provided to it by the data store 112 to identify the proper court district for the selected case 222 and then, via an I/O port 101, log on to the court system computer 110 of the proper bankruptcy court using login name and password information stored in and provided from the data store 112. (Court login credentials.) Once logged in, the file a claim module 170 will utilize other data stored in and provided by the data store 112 to enable automated navigation through various user screens of a court system's electronic filing system 110 and automated entry of relevant information necessary for filing the proof of claim. Such automated entry of relevant information may include the case number, the debtor's name, the creditor's name, and/or uploading the electronic documents (i.e., B-10 form, the exhibit form, and the proof of service documents). The file a claim module 170 may also upload electronic copies of the various loan and support documents that are required to be filed along with the proof of claim.

When the court's electronic bankruptcy filing system 110 accepts all the documents from the automated file a claim module 170, the court system's electronic filing system 110 may return an electronic receipt of the proof of claim filing to the file a claim module 170 via an I/O port 101. The file a claim module 170 will then provide an electronic copy of the filing receipt back to the database 112 to be stored as a proof of filing for the selected proof of claim filing 222. The receipt of filing the proof of claim document may be either electronic data or an electronic document depending on the court system 110 that the proof of claim is being electronically filed in by the bankruptcy claims filing system 100.

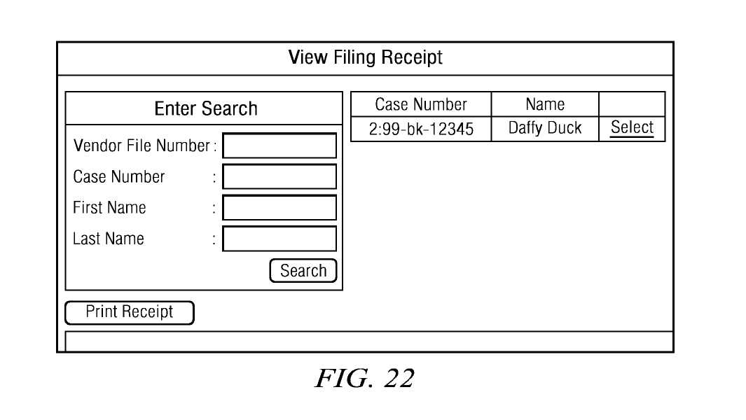

FIG. 22 depicts an exemplary screen that may be viewed by a bankruptcy specialist via the browser based GUI 106 in order to see a visual copy of the filing receipt received back from a court's electronic system after a proof of claim filing. Furthermore, in additional embodiments, the file a claim module 170 may electronically send confirmation emails 172 to a predetermined email address of the vendor or the servicer to indicate that a proof of claim has been filed along with other pertinent information related to the filed proof of claim and a copy of the receipt of a proof of claim filing receipt. Such a confirmation may, in some embodiments, be provided by the file a claim module, via fax or telecommunication transmissions.

Referring now to FIG. 12, in some embodiments a run litigation audit button 260 is provided for the bankruptcy specialist to click on or press. Upon selecting the run litigation audit button, the exemplary bankruptcy claims filing system 100 will run a litigation audit module comprising a set of rules to be applied against the data for a selected proof of claim data file. The set of rules identifies, based on the data in the particular proof of claims file, potential basis for litigation in the particular bankruptcy court or court district. In other embodiments, a litigation audit can be performed on selected proof of claim data, selected claim transfer data, or other selected data without bankruptcy specialist input. The litigation audit, via the litigation audit module, of this type is performed at a predetermined data collection or data manipulation stage of the data collection, creation or usage process. For example, a litigation audit module is initiated by the import bankruptcy data module to perform a litigation audit when new data is imported into an exemplary system from a service provider's platform. Upon completion of the litigation audit on the newly received data and audit report is made available to the service provider's platform via a browser for viewing, is sent to the service provider's platform via the XML interface 101, or sent to a predetermined email address. In other embodiments, the litigation audit module may be initiated by the file a claim module 170 prior to electronically filing a claim with a selected court. Table 2 provides exemplary rules that may be programmed into and used by an exemplary audit module 287 proof of claim data of an embodiment of a bankruptcy claims filing system 100.

TABLE 2

| | | Business rule |
|---|---|---|
| 1 | Appraisals | When the appraisals fee is greater than $ and/or what other conditions? |
| | | display this text |
| | | “Appraisal fees are $----. Appraisal fees are typically under |
| | | $1500.00. This should be the aggregate fees including an internal |
| | | inspection”. |
| 2 | Attorney's Costs | When the attorney's fees is greater than $ and/or what other conditions? |
| | | display this text |
| | | “Attorney's costs are $----. Attorney's costs are typically under |
| | | $2500.00”. |
| 3 | Corporate Advances | When the corporate advances is greater than $ and/or what other conditions? |
| | | display this text |
| | | “Corporate advances exceed or “are” $ , adjust or ignore” |
| 4 | Escrow | When the escrow advances are greater than $ and/or what other conditions? |
| | | display this text |
| | | “Escrow advances exceed $ , adjust or ignore” |
| 5 | Foreclosure fees | When the foreclosure fees are greater than $5000 and/or what other conditions? |
| | | display this text |
| | | “Foreclosure fees are $----. Foreclosure fees are typically under |
| | | $5000.00”. |
| 6 | Insurance | When the property/hazard insurance is greater than $1500 and/or what other |
| | | conditions? |
| | | display this text |
| | | “Insurance/hazard insurance is $----. Insurance is typically under |
| | | $1500.00”. |
| 7 | Hazard Insurance | When the property/hazard insurance is greater than $1500 and/or what other |
| | | conditions? |
| | | display this text |
| | | “Insurance/hazard insurance is $----. Insurance is typically under |
| | | $1500.00”. |
| 8 | Payment of | When the payment of delinquent HOA dues is greater than $ and/or what other |
| | delinquent HOA | conditions? $2000 |
| | dues | display this text |
| | | “Payment of delinquent HOA dues are $----. Payment of delinquent |
| | | HOA dues are typically under $2000.00”. |
| 9 | Property inspections | When the property inspections is greater than $500. and/or what other |
| | | conditions? |
| | | display this text |
| | | “Property inspection is $----. Property inspection is typically under |
| | | $2000.00”. |
| | | NOTE - Property Inspections should be an option to add or not to add by the persons |
| | | completing the POC as some jurdisctions do not allow them as all. |
| 10 | Recoverable balance | When the recoverable balance is greater than $ and/or what other conditions? |
| | | display this text |
| | | “Recoverable balance exceeds $ , adjust or ignore” |
| 11 | Senior lien advances | When the senior lien advances is greater than $ and/or what other conditions? |
| | | display this text |
| | | “Senior lien advances exceeds $ , adjust or ignore” |
| 12 | Tax advances | When the tax advances is greater than $5000. and/or what other conditions? |
| | | display this text |
| | | “Tax advances are $----. Tax advances are typically under $5000.00”. |
| 13 | Others | When the others is greater than $ and/or what other conditions? |
| | | display this text |
| | | “Tax others are $ , adjust or ignore” |
| 14 | Corp Advance/ | Corporate advance sometimes can include insurance and attorney fees. Corporate |
| | Property insurance/ | advance must always be explained. |
| | attorney fees | Whenever there are Corporate advances, always show the following text for Escrow |
| | | check: |
| | | “Corporate advances can sometimes include insurance and |
| | | attorney fees. Corporate advances require an explanation. Where |
| | | applicable, attach supporting documentation”. |
| 15 | Escrow | Whenever there are Escrow fees, always show the following text for Escrow check: |
| | | “Escrow fees require explanation. Where applicable, attach supporting |
| | | documentation”. |
| 16 | Note, Deed of trust, | Always ask if a note, deed of trust and assignment (where applicable). Does the |
| | assignment | beneficiary under the deed of trust match the name of the claimant? If not, have you |
| | | attached your servicing rights? |
| | | Display the uploaded document list. And display the following message: |
| | | “Please ensure that the note/deed of trust and/or assignments are |
| | | attached to the POC. In such documents, verify that the |
| | | beneficiary under the deed of trust matches the name of the |
| | | claimant. If not, please attach your servicing rights.” |
| 17 | Are there supporting | If any of the given items has a dollar amount, then display the following message. |
| | documents for . . . | The message should be displayed for each item. |
| | Appraisal fees | Show the following |
| | Attorney's fees | “Attach redacted copies of any documents that support the claim, |
| | Corporate advances | such as promissory notes, invoices, itemized statements, cancelled |
| | FCL Fees/Costs | checks, etc.” |
| | (except escrow) | |
| 18 | Trustee addresses | Verify trustee address is the same county as the debor. |
| 19 | Attached supporting | Display for each attachment. “The Administrative Office of the U.S. Courts has |
| | documents | asked us to remind all filers regarding the provisions of Federal Bankruptcy Rule |
| | | 9037 and Local Rule 6.14. These rules require that personal identifiers (i.e. |
| | | Social Security numbers, names of minor children, birthdates, financial account |
| | | numbers, etc.) be redacted from pleadings and attachments filed with the Court. |
| | | Responsibility for redacting this information rests solely with the filer.” |
| 20 | Debtor address | Verify that the debtor address is complete. Complete means address (at least one |
| | completeness | line), city, state and zip fields are not empty. If there is more than one debtor, then |
| | | check both addresses. |
| 21 | Trustee address | Verify that the debtor address is complete. Complete means address (at least one |
| | completeness | line), city, state and zip fields are not empty. |
| 22 | Debtor's attorney | Verify that the debtor address is complete. Complete means address (at least one |
| | address | line), city, state and zip fields are not empty. If “Pro se”, then flag a warning |
| | completeness | (Yellow). |
| 23 | BK Case number | The “standard” case number format in the Federal Courts of Appeal and the U.S. |
| | format check | Bankruptcy Courts is: YY-NNNN (e.g. 99-1001) or YY-NNNNN (e.g. 02-20135), |
| | | where YY is the two digit year and |
| | | NNNN(N) is a four or five digit sequence number |

The litigation audit rules may include general applicable rules to help prevent the potential for litigation with the debtor. For example, if a rule in a particular court district is that attorney's fees can be no greater than, for example $2,000, but for some reason the service provider's system 102 provided data indicating that the attorney's fees are $6,000 or the bankruptcy specialist mistakenly typed in $6,000 instead of $2,000, an exemplary litigation audit module 287 will identify that as an item of concern, flag it for the bankruptcy specialist and provide a report to the bankruptcy specialist stating something to the extent, “typically for this particular court district, attorney's fees are limited to $2,000. The present proof of claim has $6,000 for attorney's fees.” The litigation audit module 287 will then allow the bankruptcy specialist to go back and double check, via the browser 106, the numbers and fix them if necessary or ignore the audit warning depending on the situation at hand.

Referring back to FIG. 1, the get docket report module 270 is a useful module in certain circumstances. The get docket report module 270 may be used for at least two distinct situations. The first situation is when the bankruptcy specialist does not have all the needed information for filing the proof of claim. In many circumstances, a bankruptcy court may have information about the bankruptcy case that the bankruptcy specialist or the service provider does not have. In such a case, a bankruptcy specialist may, via the browser based GUI 106, utilize the get docket report module 270 and receive a docket report from the particular electronic court system 110 in which the bankruptcy case was filed. In order to do so, the get docket report module must utilize the login information stored in the data store 112 and log into the specific electronic court system 110 in an automated fashion and then navigate the user interface in an automated manner in order to request and/or require a docket report for one or more specific bankruptcy cases. A second situation that the get docket report module 270 may be heavily utilized for is in a claims transfer situation. During a claims transfer process, the bankruptcy specialist may not know all the necessary information pertaining to a previously filed proof of claim that is now being transferred to a different service provider. The get docket report module 270 is a software module that is utilized to download and obtain information from a bankruptcy court's computer system 110 and to provide the information for review and use by an exemplary bankruptcy claims filing system, via an I/O 101, for help in preparing a proper claim transfer filing. A downloaded docket report from a court system's computer 110 contains information about a selected bankruptcy case. For example, a downloaded docket report may contain information about when a bankruptcy case was filed, debtor information, claimant information, the due date for proof of claim filings, how much of the loan is claimed to be secured and unsecured and in some circumstances, copies of the loan documents.

In other embodiments of the invention, the get docket report module 270 can be set by a bankruptcy specialist automatically or periodically request and download a docket report for an existing bankruptcy case that has already been filed. Furthermore, if one or more proof of claims have been filed in a particular bankruptcy case, the get docket report module 270 can download a status report at requested or periodic times from the court's electronic filing system 110 to provide electronic status and docketed information about a proof of claim filing relevant to a selected service provider, bankruptcy case, file or files in the data store.

Embodiments of the bankruptcy claims filing system 100 provide a vast improvement over previous methods utilized by a service provider when interacting with bankruptcy attorneys or vendors who filled out necessary forms and then scanned and filed electronic filings in various different electronic filing systems of multiple different bankruptcy court systems because embodiments of the invention provide a single-location electronic filing system that includes software, which provides instructions causing a computer's or server's processor to allow receipt of proof of claim data from a plurality of service provider's platforms, which enables a bankruptcy specialist to view a summary of the data provided from the various service providers and make determinations as to whether there is misinformation input into the proof of claim data file as well as to input missing information into such proof of claim data files. An exemplary system comprises instructions that allow a bankruptcy specialist to view and confirm the data of each or selected proof of claim data files and then, when requested either by manually GUI input or via electronic communication, the instructions may further enable a transformation of such proof of claim data files into proper proof of claim electronic documentation, which may be electronically filed in one or more differently configured court electronic filing system in a standardized fashion without specifically requiring the bankruptcy specialist to understand or know how to navigate the different user interfaces of the different bankruptcy electronic filing interfaces of the one or more differently configured court filing systems. Such exemplary embodiments are a huge time saver for preparing and filing proof of claims over previously used bankruptcy claim filing methodologies. Furthermore, embodiments help to standardize and normalize the language used in proof of claim filings in the courts. In addition, embodiments provide an ability to audit proof of claim filings for potential litigious violations in such filings. Again, exemplary embodiments provide a single point or location for the management of handling a few to thousands of proof of claim filings in any or all of the various districts and bankruptcy courts across the United States.

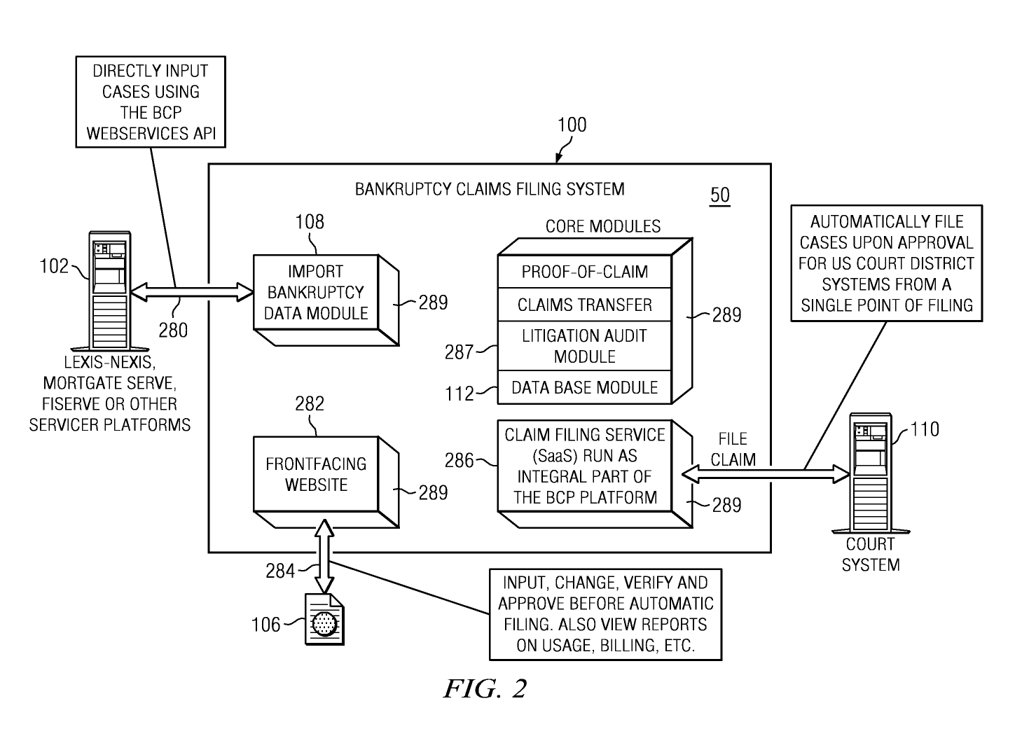

Referring now to FIG. 2, which provides a block diagram of various software modules that have instructions configured to cause a processor (not specifically shown) in the computer or server device and that is stored on a computer readable medium 289 utilized by an exemplary bankruptcy claims filing system 100. The import bankruptcy data module 108 operates to either receive bankruptcy data in an XML file (or other acceptable data format) from a service provider's platform 102 or to query a service provider's platform 102 to send bankruptcy proof of claim data via an XML file (or other acceptable data format) to the bankruptcy claims filing system 100. The communication network 280 that provides the proof of claim bankruptcy data from the service provider's platform 102 to the import bankruptcy data module 108 may be an internet network, public network or private network allowing communication between the service provider's platform 102 and the bankruptcy claims filing system 100. Furthermore, embodiments of the invention may use known or custom data files, other than XML files, to electronically provide proof of claim or claim transfer information from a service provider system 102 to the import bankruptcy data module 108.

The front-facing website module 282 is a module that interfaces with the bankruptcy specialist who is using a web browser program or other program and creates a GUI for the bankruptcy specialist to interface with an exemplary bankruptcy filing system 100. The front-facing website module 282 allows the bankruptcy specialist via the browser website 106 to input, change, verify, and approve proof of claim and claim transfer data before an automated filing. The front-facing website 282 also allows a bankruptcy specialist via the web browser 106 to review various types of bankruptcy case file reports including court docketing reports, usage reports, billing reports and others. The communication between the browser 106 and the front-facing website may be an internet communication network, public or a private communication network 284.

The claim filing service module 286 or derivations thereof are an integral part of an exemplary bankruptcy claims filing system 100. The claims filing service module 286, upon bankruptcy specialist approval, can provide instructions for logging into a prescribed one of many differing court electronic filing systems 110. Furthermore, the claim filing service module 286 contains programming that navigates such court's user interface or electronic filing interface in an automated manner without the aid of the bankruptcy specialist. The claims filing service module 286, after having logged an embodiment into a selected electronic court filing system 110, has the ability to electronically file a proof of claim or a transfer of claim using bankruptcy specialist or non-bankruptcy specialist confirmed data stored in the data store 112. A receipt indicating that a proof of claim or a transfer of claim has been filed in an electronic court filing system 110 can then be downloaded or received from the court's electronic system back to the claim filing service module 286 and then be provided for electronic storage, printout, or email to the bankruptcy specialist or the associated service provider. Furthermore, the claim filing service module 286 may contain instructions enabling processor control of or request for a download of docket reports or other court managed information. Such a download can be performed either upon a manual user request or an electronically communicated request, wherein the electronically communicated request originates via an automated methodology, from a service provider's platform or from another court's electronic filing system.

Thus, it is important to understand that some of the core abilities of various exemplary embodiments is to be able to file a proof of claim electronically in any one of a variety of courts, to be able to electronically file a request to transfer a claim for a previously filed proof of claim of one service provider to another service provider in an automated electronic form, and thirdly to perform a litigation audit of a proof of claim data file in order to flag a potential litigious data entries or non-entries in the proof of claim data file or transfer request file that may not coincide with a proper proof of claim filing or transfer of claim filing in the specific court district that the proof of claim or transfer of claim is to be filed in or according to the specific chapter of bankruptcy that the proof of claim is being filed under.

It is understood that an exemplary bankruptcy claims filing system 100 can exist as software stored on a computer readable medium and running in a processor based desktop computer, server or other reasonable derivative thereof utilizing a Window's-based operating system or another comparable operating system such as Linux or UNIX. Further, it should be understood that the contents of the data store 112 and related exemplary software may be stored and updated within a mechanical, electromechanical memory or solid state device used by the server on which the exemplary bankruptcy claims filing system 100 resides.

The data store 112 may store or keep track of a variety of different types of data in various different formats in an exemplary bankruptcy claims filing system. For example, there are four or more types of data formats that are stored using the data store 112. The first type of data is data from the service provider's XML data file that comprises proof of claim data and is stored within the data store 112 in a table format for each of the separate proof of claim files. A separate file or a combined database file may exist within the data store 112 for each service provider's proof of claim filing(s) that is to be prepared and filed. Secondly, databases within the data store 112 may include a data table or separate data files for each of the claims transfer files that need to be filed. As such, for claims transfer files, a set of data is associated to a particular bankruptcy claim. The set of data provides information about one or more proof of claim filings that are to be transferred from one service provider to a different service provider. A third type of data is the bankruptcy claim filing system user information data. This user related data keeps track of the bankruptcy specialists who may log on to an exemplary bankruptcy claims filing system 100 via a browser interface 106 for checking and verifying proof of claim data and for checking, for verifying transfer of claims data, as well as for indicating that such data is ready for automated filing via the file a claim module 170 or a claim filing service module 286. This user related data may be stored in designated tables within the data store 112. Furthermore, servicer information 102 is also stored in a database file such that the servicers 102 may log on to an exemplary bankruptcy claims filing system 100 and download a proof of claim XML file or request status about a particular case. In various embodiments, the bankruptcy claims filing system 100 stores vendor data to allow various vendor systems to log onto and utilize the import bankruptcy data module 108 and to query or pull proof of claim status data associated with the particular service provider 102 or a vendor.

A fourth type of data information that may also be stored in the data store 112 is court computer system specific information that is needed by an exemplary bankruptcy claims filing system 100 for logging (via user name and pass code login credentials) into each one of the separate court systems' electronic filing systems 110. Furthermore, this database may comprise the specific and differing court rules that must be used when filing a proof of claim or a claims transfer request in the specific court. Each court system may have their own separate rules or nuances with respect to the general, standardized rules that must be adhered to when filing in that court. Furthermore, data or instructions associated with how the claim filing service module 170, 286 must navigate the user interfaces and GUIs of each of the different court systems' electronic filing systems 110 is also stored.

It should be understood that in some embodiments, the claim filing service module 170, 286 loads or uses a specific court navigation module that has been programmed for the specific court that a proof of claim or claims transfer filing is being filed in. Each of the court navigation modules utilized by the claim filing service module 286 may access data in the data store 112 or in another computer related storage medium to aid its ability to navigate a user interface of any one specific court systems' electronic filing system 110.

Furthermore, an exemplary embodiment's data store may have a portion allocated such that litigation audit-related data can be referenced to or associated with a specific proof of claim data file. Although various databases may be utilized for storing and organizing data of an exemplary embodiment, one database that has been utilized in an exemplary system is a SQL server database style configuration. It is understood that database software other than SQL server database software may be also used.

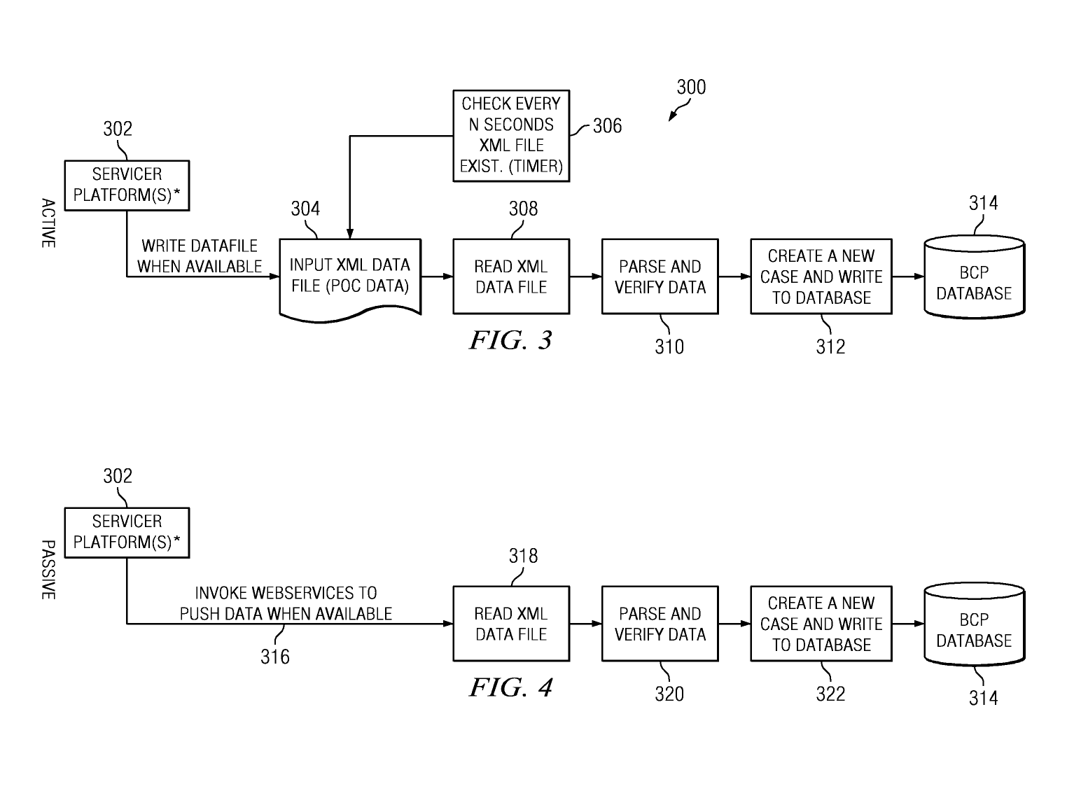

FIG. 3 depicts a flow diagram of an active data import process of proof of claim data from a service provider's platform 102 into an import data module 108 of an exemplary bankruptcy claims filing system 100. At step 302, a service provider's platform 102 may prepare a XML data file or other acceptable data file comprising proof of claim data. The XML file or other acceptable data file may be written, when it is made available by the service provider, to a predetermined storage location. The predetermined storage or data location address is pre-preprogrammed into the import data module 108 of an exemplary embodiment. At step 304, the proof of claim data is stored or placed by the servicer platform into the predetermined data location. The predetermined data location may be associated with or located as part of the service provider's electronic platform. In other embodiments, the predetermined data or storage location may be elsewhere on a private network or the internet.

At step 306, the import data module 108 checks the predetermined storage location every n seconds (every predetermined number of seconds) or periodically to determine whether or not an XML file or other data file has been deposited or stored there. If an XML file was deposited in the predetermined location, at step 308 the import data module 108 reads the XML data file from the predetermined storage location. The import data module 108 then parses and verifies the data to check that a predetermined minimum amount of data items have been provided in the proof of claim XML data file and that the data provided is of a proper format for use in the exemplary bankruptcy claims filing system 100.

At step 312, a new electronic case file is created in the data store 112 and in step 314 the parsed and verified proof of claim data is written into the newly created case data file in the data store 112. At this point in time, the data in the newly created case file may still be considered raw data, but this data has met a predetermined minimal verification requirement such that a new case data file could be created in a database file or data file in the data store 112.

FIG. 4 also depicts data import process flow diagram similar to the one of FIG. 3, but FIG. 4 describes a passive embodiment where information for a proof of claim filing is pushed from a service provider's platform server 102 into an exemplary bankruptcy claims filing system 100. Here in step 302, the service provider platform creates a proof of claim data package that is, for example, an XML data file or other acceptable data file. The network, internet or web service utilized in an embodiment are invoked to push the XML data file or other data file from the service provider's platform 102 directly into the import data module 108, wherein at step 318 such XML data is read. Step 320 parses and verifies the raw XML proof of claim data in a manner similar to step 310 in FIG. 3. In step 322, the input bankruptcy data module creates a new bankruptcy case data file and or database file for the raw data and writes such data into the appropriate database or data file within the data store at step 314.

As such, the data import process flow of FIG. 3 is proactive in that an exemplary embodiment actively checks for and retrieves a new proof of claim data file while the data import process flow of FIG. 4 is considered passive because an exemplary embodiment waits for the service provider's platform 102 to push proof of claim data to an exemplary embodiment's import bankruptcy data module 108.

Thus, in FIG. 4, the service provider's platform 102 determines when and how to push the data to the exemplary embodiment, while in the FIG. 3 embodiment the exemplary bankruptcy claims filing system 100 periodically looks for and downloads data provided from a service provider's platform.

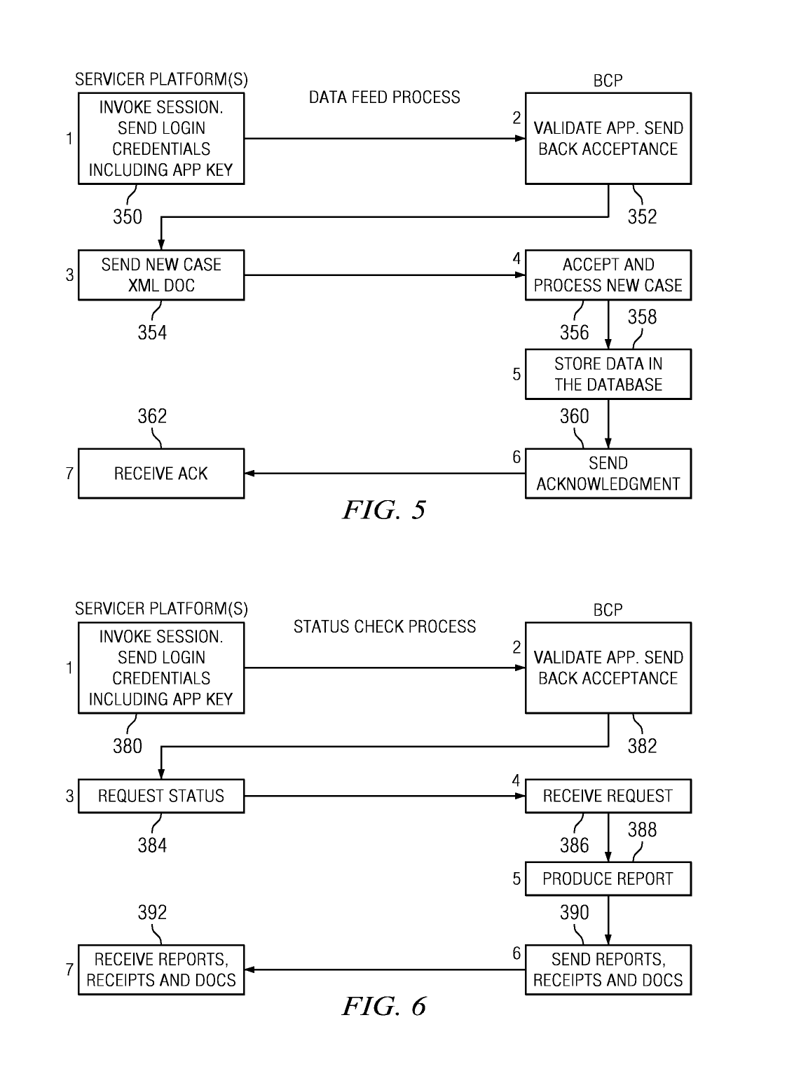

Referring now to FIG. 5, a data feed process flow diagram depicts the interaction between the servicer platform 102 and an exemplary bankruptcy claims filing system 100. This flow diagram provides additional detail to FIG. 4 with respect to a service provider's platform 102 pushing data to an exemplary bankruptcy claims filing system 100. At step 350, the service provider's platform 102 must electronically invoke a session in order to communicate with an exemplary bankruptcy claims filing system 100. To do so, the service provider platform 102 may send its login credentials along with an application key. The application key may be utilized for the encryption and decryption of data. This encryption key is important due to embodiments of the invention allowing multiple different service provider platforms to provide XML data across potentially unsecure communication networks. The application key or encryption security technique is utilized to ensure that the data has a predetermined level of encryption security associated with it. The security application key is also utilized by embodiments of the invention to identify which service provider's platform 102 is communicating with the exemplary embodiment of the bankruptcy filing system.

At step 352, the electronic bankruptcy filing system receives the login credentials and application key and then validates the application key thereby validating the service provider's platform as being a platform authorized to utilize the exemplary electronic bankruptcy filing system 100. As a result, the exemplary electronic bankruptcy filing system returns an acceptance notification to the service provider platform. At step 354, the service provider platform is ready to send a new proof of claim XML data file or a transfer of proof of claim request document to the exemplary bankruptcy filing system 100. At step 356, the XML data file or other type of data file is accepted by the import data module 108 and a new case data file is created in the data store 112. At step 358, the new XML data is stored in the data store 112 in the newly created data file. At step 360, the exemplary bankruptcy claims filing system sends an acknowledgement of receipt back to the service provider platform via the same communication network on which the XML file was received. The acknowledgement is received by the service provider platform at step 362. In this exemplary data feed process, an exemplary embodiment is passively receiving and accepting pushed data from a service provider's platform 102 without having to go out into the network and query each service providers' platform or other address(es) or storage location(s) individually.

If there is a problem in receipt of the login credentials, the application key or receipt of the XML data file or other type of data file, an embodiment of the invention will simply reject the data or reply to the service provider platform with an indication that an error has occurred and that the data file was not received or the service provider platform was unable to login to the system.

Referring now to FIG. 6, a status check process flow diagram is provided, which is a programmed module that may be part of or closely associated with the import data module 108. Here at step 380, a session from a service provider's platform is invoked when the service provider platform electronically sends, over a network, its login credentials, which includes an application key for security as discussed above with respect to step 350. At step 382, the login credentials and security application key are validated and a login acceptance is sent back to the service provider's platform. At step 384, the service provider platform 102 may send a status request indicating a particular bankruptcy case, proof of claims filing, or transfer of proof of claims filings to the exemplary bankruptcy claims filing system 100. The status request may include data designating the bankruptcy case of interest by including the bankruptcy case number, an investor number and in some embodiments, the loan number that the proof of claim is associated with. It should be understood that the service provider's loan number or internal designation may or may not be the same as the vendor file number for the same case. At step 386, the bankruptcy claims filing system receives the request and utilizes its database file's contents with data store 112 to determine a status of the designated proof of claims filing as to whether it has been approved or filed, who is the designated bankruptcy filing specialist for the filing, whether there was an error in filing the proof of claim, whether a filing receipt has been received from the court and perhaps a litigation audit report generated from the data within the particular proof of claim data file. At step 388, the report is generated using appropriate database software. At step 390, the generated report is sent back to the service provider's platform via a private network, the internet, a confirmation email, or fax or regular mail 172 from FIG. 1. At step 392, the servicer platform 102, which requested the status check, receives the reports and/or documents that were sent from an exemplary electronic bankruptcy filing system.

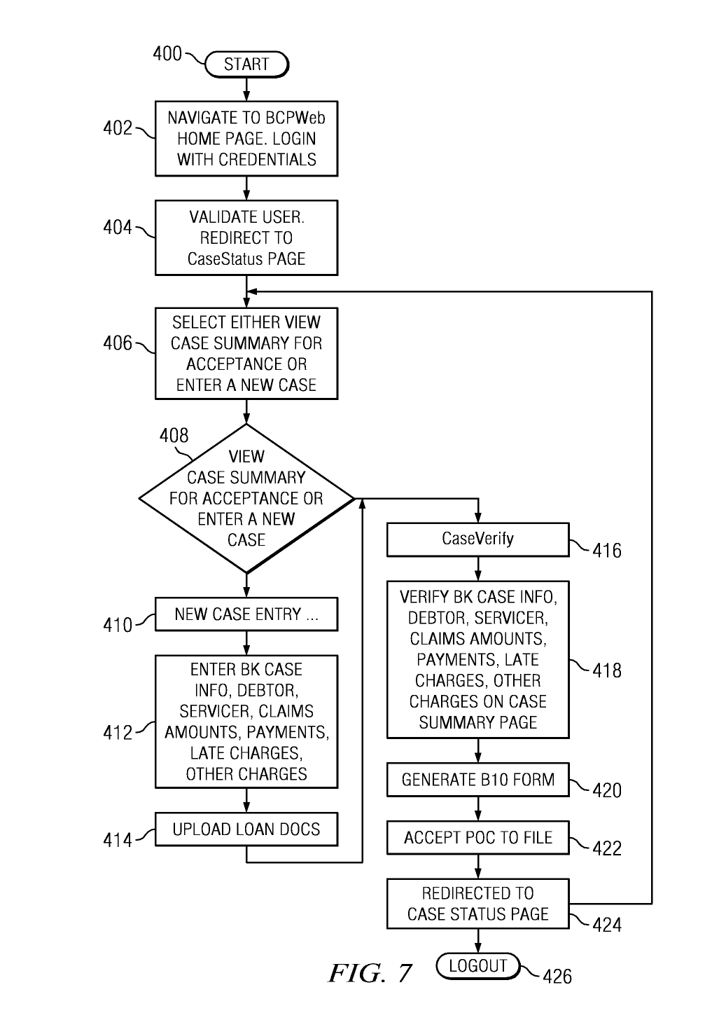

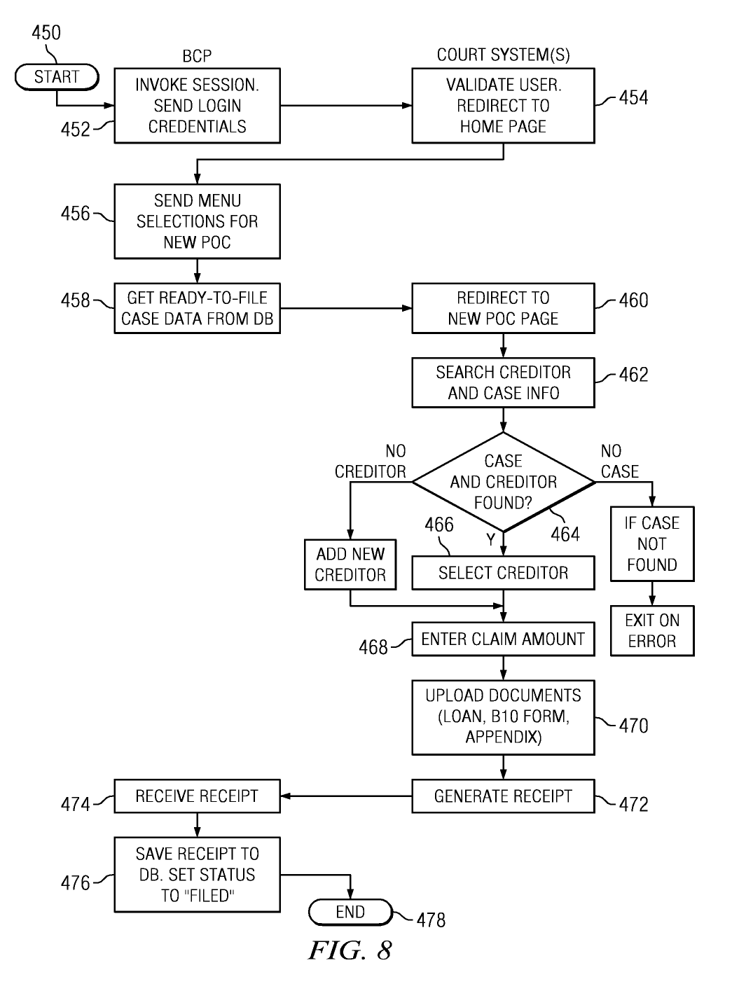

Referring now to FIG. 7, a user interaction process flow is provided, which provides additional detail about the bankruptcy file specialist's interaction within an exemplary electronic bankruptcy filing system. At step 400, the bankruptcy specialist uses a user terminal (not specifically shown). At step 402, the bankruptcy specialist navigates via a browser program or other graphic user interface program to the front-facing web site module 284. Once at this web site, the bankruptcy specialist logs into the front-facing web site module 284 using a user name and password or other login credentials. Upon a successful login in step 404, the front-facing website module 282 provides a web page via the bankruptcy specialist's web browser. In one embodiment, a case status information page or screen is viewed by the bankruptcy specialist. An exemplary case status information screen page is shown in FIG. 10. A bankruptcy specialist can view all the cases that are assigned to him to review 202 of FIG. 10, at the case status page 200. The bankruptcy specialist can redirect the browser-based page to another page wherein he can confirm a case for acceptance or proceed to another screen page to manually enter a new proof of claim case. At step 408, the bankruptcy specialist views the case summary or status information page and can decide what he or she is going to do next.

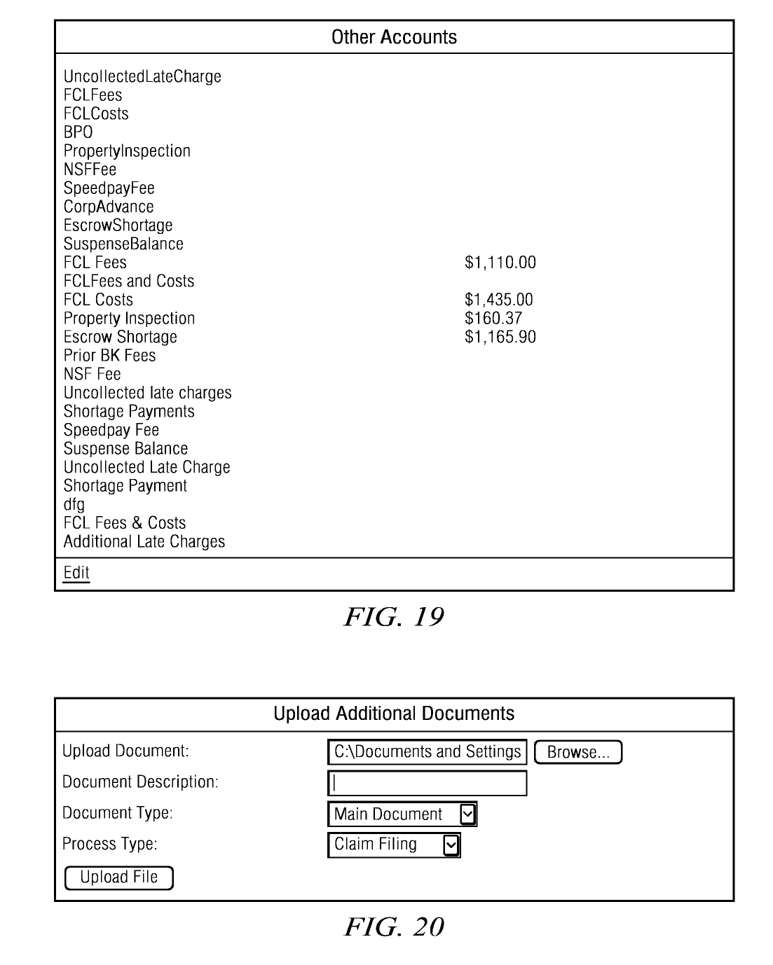

If the bankruptcy specialist decides to enter a new proof of claim case at step 410, he is redirected to a general information page that would contain similar entries to those shown in FIG. 13. The bankruptcy specialist may need to navigate through the enter debtor page shown in FIG. 14, the enter attorney page shown in FIG. 15, the enter trustee page shown in FIG. 16, the claim total information page shown in FIG. 17, the payment breakdown page shown in FIG. 18 and any other exemplary screen pages such as FIG. 19 or other pages to manually enter information associated with a proof of claim filing at step 412. At step 414, for certain jurisdictions the bankruptcy specialist may be requested to upload additional documents, such as the Form 10 document, electronic copies of the service provider's loan documents or other documents required in support of the proof of claim filing. Some exemplary browser screens for uploading of loan documents are shown in FIGS. 20 and 21. As such, a bankruptcy specialist may manually enter proof of claims filing information for proof of claim filings that have not been provided to an exemplary bankruptcy claims filing system electronically via an XML data file from a service provider.

After any additional and necessary data is manually inserted into a proof of claim data file at step 408, the bankruptcy specialist may choose to review via the GUI a case file data summary for a previously entered proof of claim case data and determine if it is ready for acceptance and filing. The bankruptcy specialist is directed to a case data verify screen at step 416 so that the bankruptcy specialist can review one or more screens and verify that all the proper entries have been made for a proof of claim filing and that the spelling, the addresses and associated numbers of all the entries are correct. At step 418, the bankruptcy specialist can be redirected to or can navigate through the various exemplary browser based screens and correct, edit or add information for the proof of claim filing as needed. The bankruptcy specialist may navigate back to the confirmation page shown in FIG. 11 and select the confirm to file box 260. It should be understood that prior to selecting the confirm to file box, the bankruptcy specialist may have already run a litigation audit program module for the particular proof of claim case to help determine whether the proof of claim filing information meets the requirements of the specific court district and the specific chapter of bankruptcy under which the proof of claim filing is to be filed.

After a proof of claim data file's contents have been confirmed by a bankruptcy specialist at step 420, a claim filing service module 286 utilizes the confirmed proof of claim filing data and the associated uploaded loan documents to generate a B-10 form, which is a standardized form used when filing a proof of claim filing. As such, the data or information that was provided from a service provider and then reviewed, edited and added to by a bankruptcy specialist is transformed into a different state in the form of an electronic B-10 form, by the file the claim or claim filing service module(s) 170, 268. Any associated electronically stored loan documents may be electronically attached to or electronically associated with the created B-10 form.

At step 422, in some embodiments, the bankruptcy specialist may review a graphic depiction of the proof of claim documentation on the browser GUI screen in the form of the B-10. The bankruptcy specialist may choose to also review any other created documents and/or any electronic copies of loan forms. Then upon approval thereof the bankruptcy specialist may select the confirm to file box 260. Upon checking the confirm to file box 260, the front-facing website module 282 will redirect the web browser to a screen providing the case status page at step 424 wherein the bankruptcy specialist may select to view another case summary for acceptance, enter a new proof of claim case at step 406 or log out of the exemplary GUI at step 426.

Refer now to FIG. 8, which depicts an exemplary process flow diagram of how an exemplary electronic bankruptcy filing system 100 interacts with a court's electronic filing system interface 110. When an exemplary electronic filing system 100 is ready to file a proof of claim via the file a claim module 170, the process begins at step 450. At step 452, the file a claim module 170 or claim filing service module 286 utilizes data provided from a database file for the particular proof of claim being filed to determine the proper district and court to file the proof of claim electronic data and electronic documentation. The file a claim module 170 then selects the proper court and district filing module and proceeds to invoke a session with the selected electronic court interface for the selected court. Login credentials from a login credential database or table in the data store 112 are utilized to login to the selected court system 110. The session with the court system is thereby initiated and at step 454, the court's electronic filing system 110 validates the user's credentials and directs the file a claim module 170, 286 to the home page or other designated page of the selected court system's electronic filing system 110. It should be understood that in the past a user, such as a bankruptcy specialist, would manually log in to a court's electronic filing system 110 via a browser device or other network connection and have to manually navigate the pages of the court's graphic user interface (GUI). In embodiments of the invention, the file a claim module 170, 286 logs in, in an automated manner, and at step 456, selects and navigates the proper page(s) and menu selections for filing a proof of claim. After the menus have been properly navigated in an automated manner and the selection for filing the proof of claim has been made, the file a claim module 170, 286 prepares (in some embodiments) and finalizes the proper electronic documents and data using associated contents stored in the data store 112 for this proof of claim filing at step 458. In response to the selection by the file a claim module 170, 286 indicative of wanting to file a new proof of claim, at step 460, the court's electronic filing system redirects its graphic interface to a new proof of claim page. It should be understood that although not specifically shown in this flow diagram, as the court system's graphic user interface moves from page to page querying, requesting and receiving information to be provided by the automated file a claim module, the automated file a claim module responds in a pre-programmed manner using information provided from the data store 112. In step 462 and after the bankruptcy case number has been provided by the electronic bankruptcy filing system, a search of creditors and case information is most likely performed by the court system's devices 110. After the particular bankruptcy case and the name of the creditor associated with the proof of claim to be filed is found by the court system 110, the court system's electronic filing system may require the module 170, 286 to select the specific creditor, enter the claim amount and upload all of the necessary documents, such as the loan document, the B-10 form and other related documents so that the proof of claim is filed with the bankruptcy court in steps 462-470. At step 472, the court's system may generate an electronic filing receipt, which is provided back to the file a claim module 170, 286 and received at step 474. At step 476, the electronic receipt is saved to the data store 112 and the status of the proof of claim filing is set to filed. Also at this time, a confirmation email 172 may be sent to a service provider email address by the file a claim module as an indication that the proof of claim has been filed and a filing receipt therefore was received. FIG. 1 depicts a confirmation email 172 being sent. This particular court system interaction is completed and ended at step 478, wherein the session between an exemplary electronic bankruptcy filing system and a court's electronic filing system is ended. It is understood that the programmed interaction for different court systems 110 may and in many situations will differ.

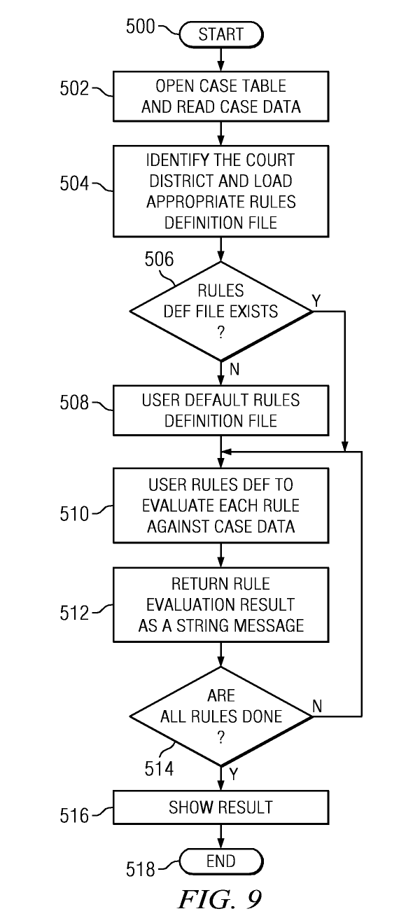

Referring now to FIG. 9, an exemplary litigation audit flow chart is provided starting with step 500. When a bankruptcy specialist wants to perform a litigation audit, he may click or select the run litigation audit button or link 260 as shown, for example, in FIG. 12. The bankruptcy specialist will generally select the run litigation audit button 260 while in a web browser mode 106 using the import data module 108 along with needed database and file data from the data store 112 or the front-facing website module 282. The litigation audit module 287 will then search the data store 112 for an audit rules module 287 for the particular court district that the proof of claim is to be filed in. At step 506, it is determined whether the specific court district has its own particular rules and at step 508, if there are no specific rules for the particular court district for the proof of claim filing, then default rules that have been programmed into the module are utilized for performing the litigation audit. Conversely, if the specific rules are found in step 506, then the import data module 108 or the front-facing website module 282 utilizes those rules to evaluate the data and documents provided in the particular proof of claim filing data at step 510. The below Table 3 shows an example of some exemplary default or generic litigation audit rules in accordance with an embodiment.

TABLE 3

| | | Business rule |
|---|---|---|
| 1 | appraisals | When the appraisals fee is greater than $ and/or what other conditions? |
| | | display this text |
| | | “Appraisals fee excesses $1500 , adjust or ignore” |
| 2 | attorney's fees | When the attorney's fees is greater than $ and/or what other conditions? |
| | | display this text |
| | | “Attorney's fees excesses $2500 , adjust or ignore” |
| | | Add attorney “costs’ excess $ , adjust or ignors. |
| 3 | corporate advances | When the corporate advances is greater than $ and/or what other |
| | | conditions? |
| | | display this text |
| | | “Corporate advances excesses $ , adjust or ignore” |
| | | Talk to Bill re adding; “Corporate advance “breakdown” ... |
| | | THIS IS BASED ON SCHEDULED P&I PAYMENTS, WHICH SHOULD |
| | | BE REIMBURSED BY THE TRUST. |
| 4 | escrow | When the escrow advances are greater than $ and/or what other |
| | | conditions? |
| | | display this text |
| | | “Escrow advances $ , adjust or ignore” |
| | | A STATE TABLE WOULD BE OF SOME HELP BUT WITHIN STATES |
| | | THERE CAN BE LARGE DIFFERENCE. |
| 5 | foreclosure fees | When the foreclosure fees are greater than $5000 and/or what other |
| | | conditions? |
| | | display this text |
| | | “Foreclosure fees excesses $ , adjust or ignore” |
| 6 | insurance | When the property/hazard insurance is greater than $1500 and/or what |
| | | other conditions? |
| | | display this text |
| | | “insurance excesses $ , adjust or ignore” |
| | | SAME AS ESCROW. |
| 7 | payment of delinquent HOA dues | When the payment of delinquent HOA dues is greater than $ and/or |
| | | what other conditions? $2000 |
| | | display this text |
| | | “Payment of delinquent HOA dues excesses $ , adjust or ignore” |
| 8 | property inspections | When the property inspections is greater than $500. and/or what other |
| | | conditions? |
| | | display this text |
| | | “Property inspections excesses $ , adjust or ignore” |
| | | NOTE - Property Inspections should be an option to add or not to add by the |
| | | persons completing the POC as some jurdisctions do not allow them as all. |
| 9 | recoverable balance | When the recoverable balance is greater than $ and/or what other |
| | | conditions? |
| | | display this text |
| | | “Recoverable balance excesses $ , adjust or ignore” |
| | | This number does not need to be referenced as a ck point. |
| 10 | senior lien advances | When the senior lien advances is greater than $ and/or what other |
| | | conditions? |
| | | display this text |
| | | “Senior lien advances excesses $ , adjust or ignore” |
| | | This number does not need to be referenced as a ck point. |
| 11 | tax advances | When the tax advances is greater than $5000. and/or what other |
| | | conditions? |
| | | display this text |
| | | “Tax advances excesses $ , adjust or ignore” |
| | | LOCATION WILL DICTATE. STATE TABLE. |
| 12 | others | When the others is greater than $ and/or what other conditions? |
| | | display this text |
| | | “Tax others $ , adjust or ignore” |
| | | Add “others” need to be detailed and explained so the person doing the poc |
| | | can add item by item with a total at the end. |

At step 512, a first litigation audit rule is evaluated with respect to associated data within the proof of claim data file being audited and a message or a display is provided to the bankruptcy specialist indicating whether or not the audit step passed or failed. In some embodiments, a description of why there is a failure is also provided. At step 514, it is determined whether or not all of the bankruptcy audit rules have been evaluated against the proof of claim data and if more audit rules need to be applied then the program or method flow loops back to step 510 and 512 until all the rules have been completed.

Once all of the audit rules are completed at step 516, the results are shown via the web browser 106 to the bankruptcy claims specialist who requested the audit. It is the bankruptcy's specialist's decision whether to make edits, additions or changes to the proof of claim data based on the evaluation results of the litigation audit module portion 287. At step 518, the litigation audit flow is completed.

As such, embodiments of present invention provide a means for accepting proof of claim and/or claim transfer data from a service provider and/or a bankruptcy specialist in a variety of formats. Such data is stored in a database that may be viewed, analyzed and audited by specialized software and then filed in one of a plurality of bankruptcy courts electronically and in an automated fashion. Embodiments help standardize the way proof of claim filings are written and filed. In addition, embodiments streamline and allow proof of claim filings to be less expensive to prepare for the service providers, who are already concerned that they will collect less money from a debtor than anticipated due to the bankruptcy filing. Additionally, embodiments may not require a bankruptcy specialist to be comfortable navigating each and every different court system's electronic proof of claim filing system interface or GUI because embodiments of the invention comprise a module, which is programmed to automate such navigation of different court's electronic filing systems and GUIs. Embodiments provide a never before provided and streamlined mechanism for organizing, filing and tracking many proof of claim filings for a plurality of different service providers and bankruptcy specialists via a single system or point of operation. In other embodiments software based audit software modules enable a bankruptcy specialist or a service provider's platform to take advantage of perhaps little known or forgotten rules that are specific to only a few of the many court districts. Such rules may be overlooked by a specialist if this exemplary system was not utilized. Furthermore, embodiments of the invention decreases the amount of time required for preparing, organizing, and filing proof of claim filings by a user who previously filed proof of claims in a more manual manner. In essence, the users of an exemplary system who are being trained to prepare and file proof of claim filings can be trained in a shorter period of time due to an advantage of exemplary embodiments that does not require users to know which court or court district is the correct place to file a proof of claim or many other specific nuances associated with proof of claim filings or transfer of claims filings in the various court districts. Also, in certain aspects of the invention, a service provider may be able to prepare a complete proof of claim data file that is ready for transformation into a proof of claim filing from its business office service platform 102 without any interaction with a bankruptcy specialist, thereby decreasing the overall cost of filing a proof of claim to the service provider or lender who is already in the awkward position of attempting to collect on a loan that has found itself in a bankruptcy proceeding. Furthermore, from the environmental perspective, this exemplary system provides a paperless means for preparing and filing proof of claim filings. In fact, the entire process may be accomplished from the service provider's platform 102 to the return of any confirmation or filing receipts from the court system's electronic system 110 without paper.

It will be appreciated by those skilled in the art having the benefit of this disclosure that an exemplary electronic bankruptcy claims filing system provides a system and method for receiving, organizing, preparing and filing proof of claim filings electronically with a bankruptcy court in an efficient, cost effective, standardized and automated manner. It should be understood that the drawings and detailed description herein are to be regarded in an illustrative rather than a restrictive manner, and are not intended to be limiting to the particular forms and examples disclosed. On the contrary, included herein are discussions and implications of modifications, changes, rearrangements, substitutions, alternatives, design choices, and embodiment variations that would be apparent to those of ordinary skill in the art, without departing from the spirit and scope hereof, and as defined by the following claims. Thus, it is intended that the following claims be interpreted to embrace all such further modifications, changes, rearrangements, substitutions, alternatives, design choices, and embodiments.

What is claimed is:

1. An electronic bankruptcy claims filing system, said filing system comprising:
a computer device, the computer device comprising:
a computer readable medium;
at least one input/output port adapted for connection to a network;
a processor electronically coupled to the computer readable medium and to the at least one input/output port; and
a plurality of instructions wherein at least a portion of the plurality of instructions are storable in the computer readable medium, and further wherein the plurality of instructions are configured to cause the first processor to perform:
accepting a proof of claim data file from a servicer platform via the input/output port;
verifying that predetermined data items are present in the proof of claim data file;
creating a proof of claim database file in the computer readable medium for storing proof of claim data, the proof of claim data comprising at least the predetermined data items;
storing said predetermined data items in the proof of claim database file;
providing a pass code protected browser interface for a bankruptcy specialist to access, the pass code protected browser interface comprising a graphic user interface for the bankruptcy specialist to view, edit, add to or confirm the proof of claim data in the proof of claim database file;
transforming the proof of claim data into at least one electronic document in accordance with requirements of a selected court district in which a proof of claim is to be filed, the at least one electronic document comprising at least one of a B-10 form, an Exhibit form, and a Proof of Service form;
invoking a session with the selected court district's electronic filing system via the at least one input/output port;
navigating, without human interaction, the selected court district's electronic filing system's graphic user interface and searching for a specific electronic bankruptcy case file;
uploading the at least one electronic document, via the at least one input/output port, to the selected court district's electronic filing system in order to file the proof of claim with the specific electronic bankruptcy case file;
receiving a proof of claim filing receipt from the selected court district's electronic filing system via the at least one input/output port; and
updating the proof of claim database file to indicate that a proof of claim filing receipt was received; and
storing the proof of claim filing receipt in the proof of claim database file.

2. The filing system of claim 1, further comprising a plurality of proof of claim database files stored on the computer readable medium, and wherein the pass code protected browser interface further comprises a graphic user interface for the bankruptcy specialist to selectively view, edit, or confirm specific proof of claim data associated with a selected one of the plurality of proof of claim database files.

3. The filing system of claim 1, wherein the proof of claim data comprises case number information, bankruptcy court information, creditor information, debtor information, claim amount information, attorney information, trustee information, late charges information, and fees information.

4. The filing system of claim 1, further comprising performing a litigation audit on the predetermined data items if the bankruptcy specialist selects a litigation audit to be performed via the graphic user interface.

5. The filing system of claim 1, further comprising a court login credential file stored in the computer readable medium, the court login credential file comprises court login credentials for a plurality of court district's electronic filing systems, and wherein the selected court district's electronic filing system is one of the plurality of court district's electronic filing systems.

6. The filing system of claim 1, wherein the electronic documents further comprise loan documents.

7. The filing system of claim 1, wherein accepting the proof of claim data file from the servicer platform via the input/output port further comprises checking a predetermined storage location for a new proof of claim data file.

8. The filing system of claim 1, wherein accepting the proof of claim data file from the servicer platform via the input/output port further comprises validating a service provider's login credentials prior to accepting the proof of claim data file and sending an acknowledgement to the servicer platform indicative of a receipt of the proof of claim data file.

9. The filing system of claim 1, further comprising providing status of a proof of claim to a service provider, the providing status comprising:
validating a service provider's login credentials prior to accepting a proof of claim status request from the service provider, the proof of claim status request comprising information identifying a particular proof of claim data file;
generating a proof of claim status report incorporating information from the particular proof of claim data file; and
providing the proof of claim status report to the servicer platform electronically.

10. The electronic bankruptcy claims filing system of claim 1, further comprising providing status of a proof of claim to a service provider, the providing status comprising:
accepting a proof of claim status request from the service provider, the proof of claim status request comprising information identifying a particular proof of claim data file;
generating a proof of claim status report incorporating information from the particular proof of claim data file; and
providing the proof of claim status report to the servicer platform electronically.

11. An electronic bankruptcy claims filing system, said filing system comprising:
a computer device, the computer device comprising:
a computer readable medium;
at least one input/output port adapted for connection to a network;
a processor electronically coupled to the computer readable medium and to the at least one input/output port; and
a plurality of instructions wherein at least a portion of the plurality of instructions are storable in said computer readable medium, and further wherein the plurality of instructions are configured to cause the first processor to perform:
accepting a claim data file from a servicer platform via the input/output port, the claim data file being one of a proof of claim data file and claim transfer file;
creating a claim database file in the computer readable medium for storing claim data, the claim database file comprising a data type indicating whether the claim database file comprises proof of claim data or claim transfer data;
storing the predetermined data items in the claim database file;
selecting the claim database file;
if the data type indicates that the claim data in the selected claim database file comprises proof of claim data, then transforming the proof of claim data into at least one electronic document, each electronic document in accordance with specific requirements of a selected court district in which a proof of claim is to be filed;
if the data type indicates that the claim data in the selected claim database file comprises claim transfer data and the bankruptcy specialist confirms the claim data, then transforming the claim transfer data into at least one electronic document in accordance with specific requirements of a selected court district in which a claim transfer filing is to be filed;
invoking a session with the selected court district's electronic filing system via the at least one input/output port;
navigating, without human interaction, the selected court district's electronic filing system's graphic user interface and searching for a specific electronic bankruptcy case file;
uploading the at least one electronic document, via the at least one input/output port, to the selected court district's electronic filing system in order to file the at least one electronic document with the specific electronic bankruptcy case file;
receiving a filing receipt from the selected court district's electronic filing system via the at least one input/output port; and
updating the selected claim database file to indicate that the at least one electronic document was electronically filed and that the filing receipt was received; and
storing the filing receipt in the claim database file.

12. The filing system of claim 11, wherein selecting the claim database file comprises:
providing a pass code protected browser interface for a user to access, the pass code protected browser interface comprises a graphic user interface (GUI) enabling the user to select the claim database file and then view, edit, add to or confirm the claim data in the selected claim database file prior to the claim data being transformed into at least one electronic document.

13. The filing system of claim 11, wherein if the data type indicates that the claim data in the claim database file comprises proof of claim data, then the claim data in the claim database file further comprises bankruptcy court data, case number data, debtor data, creditor data, attorney data, fee data and claim amount data.

14. The filing system of claim 11, wherein if the data type indicates that the claim data in the claim database file comprises transfer of claim data, then the claim data in the claim database file further comprises bankruptcy court data, case number data, debtor data, transferee data and transferor data.

15. The filing system of claim 11, further comprising performing a litigation audit on a bankruptcy specialist selected claim database file comprising proof of claim data if the bankruptcy specialist selects a litigation audit to be performed via the graphic user interface.

16. The filing system of claim 15, wherein performing a litigation audit comprises applying predetermined rules associated with the selected court district to the proof of claim data, evaluating whether a proof of claim data conforms with the rule, and providing a result message to the bankruptcy specialist.

17. An electronic bankruptcy claims filing system, said filing system comprising:
a computer device, the computer device comprising:
a computer readable medium, the computer readable medium comprising
a database, the database comprising a proof of claim database and a claim transfer database;
at least one input/output port adapted for connection to a network;
a processor electronically coupled to the computer readable medium and to the at least one input/output port; and
a plurality of instructions wherein at least a portion of the plurality of instructions are storable in said computer readable medium, and further wherein the plurality of instructions are configured to cause the first processor to perform:
providing a browser interface for a bankruptcy specialist to access, the browser interface comprising a graphic user interface for the bankruptcy specialist to input, view, edit, add to or confirm data in a bankruptcy specialist created or selected proof of claim database file in the proof of claim database or a claim transfer database file in the claim transfer database;
if the bankruptcy specialist created or selected proof of claim database file is confirmed by the bankruptcy specialist, then transforming the proof of claim database file into at least one electronic document, each electronic document being in accordance with specific requirements of a selected court district in which a proof of claim is to be filed;
if the bankruptcy specialist created or selected claim transfer database file is confirmed by the bankruptcy specialist, then transforming the claim transfer database file into at least one electronic document being in accordance with specific requirements of a selected court district in which a claim transfer filing is to be filed;
invoking a session with the selected court district's electronic filing system via the at least one input/output port;
navigating, without human interaction, the selected court district's electronic filing system's graphic user interface and searching for a specific electronic bankruptcy case file;
uploading the at least one electronic document, via the at least one input/output port, to the selected court district's electronic filing system in order to file the at least one electronic document with the specific electronic bankruptcy case file;
receiving a filing receipt from the selected court district's electronic filing system via the at least one input/output port;
updating the datastore to indicate that the at least one electronic document was electronically filed and that the filing receipt was received; and
storing the filing receipt in the datastore.

18. An article of manufacture for operation of an electronic bankruptcy claims filing system, said article of manufacture comprising:
a computer readable medium;
a plurality of instructions wherein at least a portion of the plurality of instructions are storable in the computer readable medium, and further wherein the plurality of instructions are configured to cause a processor in a computer to perform the steps of:
providing a browser interface for a bankruptcy specialist to access, the browser interface comprising a graphic user interface configured to enable the bankruptcy specialist to input, view, edit, add to or confirm data in a bankruptcy specialist created or selected proof of claim database file located in a proof of claim database or a claim transfer database file located in a claim transfer database;
if the bankruptcy specialist created or selected proof of claim database file is confirmed by the bankruptcy specialist, then transforming the proof of claim database file into at least one electronic document, each electronic document being in accordance with requirements of a selected court district in which a proof of claim is to be filed, the at least one electronic document comprising at least one of a B-10 form, an Exhibit form, and a Proof of Service form;
if the bankruptcy specialist created or selected claim transfer database file is confirmed by the bankruptcy specialist, then transforming the claim transfer database file into at least one electronic document being in accordance with requirements of a selected court district in which a claim transfer filing is to be filed;
invoking a session with the selected court district's electronic filing system via the at least one input/output port;
navigating, without human interaction, the selected court district's electronic filing system's graphic user interface and searching for a specific electronic bankruptcy case file;
uploading the at least one electronic document, via the an input/output port of the computer, to the selected court district's electronic filing system in order to file the at least one electronic document with the specific electronic bankruptcy case file;
receiving an electronic filing receipt from the selected court district's electronic filing system via the one input/output port.

19. The article of manufacture of claim 18, wherein the plurality of instructions further comprise:
accepting a proof of claim data file from a servicer platform a second input/output device on the computer;
verifying that predetermined data items are present in the proof of claim data file, the predetermined data items comprising case number data, debtor data, servicer data; and claim amount data;
creating a proof of claim database file located in the proof of claim database, the predetermined data items comprising a subset of data items that can be stored in the proof of claim database file; and
storing the predetermined data items in the proof of claim database file.
